(19) United States
(12) Patent Application Publication
(10) Pub. No.: US 2025/0244862 A1
(43) Pub. Date: Jul. 31, 2025

(54) METHODS AND APPARATUS TO MONITOR AND MANAGE LOADING DOCKS AND FACILITY OPERATIONS

(71) Applicant: RITE-HITE HOLDING CORPORATION, Milwaukee, WI (US)

(72) Inventor: Richard Mews, Bonduel, WI (US)

(21) Appl. No.: 19/043,132

(22) Filed: Jan. 31, 2025

Related U.S. Application Data
(60) Provisional application No. 63/627,592, filed on Jan. 31, 2024.

(51) Int. Cl. G06F 3/04845; G06F 3/0481; G06F 3/04847

(52) U.S. Cl. CPC G06F 3/04845; G06F 3/0481; G06F 3/04847

(57) ABSTRACT

Systems, apparatus, articles of manufacture, and methods to monitor and manage loading docks and facility operations are disclosed. An example apparatus comprising at least one memory, machine readable instructions, and at least one programmable circuit to be programmed by the machine readable instructions to present, via graphical user interface, a layout of the material handling facility, the layout including multiple locations where material handling equipment is to be represented, the locations corresponding to at least one of docks or doorways of the material handling facility, associate data from first equipment at a first one of the at least one of the docks or the doorways corresponding to a first location of the multiple locations included in the layout, and generate a graphic to be presented, via the graphical user interface, at the first location, the graphic based on the data from the first equipment.

### RELATED APPLICATION(S)

This patent claims the benefit of U.S. Provisional Patent Application No. 63/627,592, which was filed on Jan. 31, 2024. U.S. Provisional Patent Application No. 63/627,592 is hereby incorporated herein by reference in its entirety. Priority to U.S. Provisional Patent Application No. 63/627,592 is hereby claimed.

### FIELD OF THE DISCLOSURE

This disclosure relates generally to monitoring systems and, more particularly, to methods and apparatus to monitor and manage loading docks and facility operations.

### BACKGROUND

In recent years, loading docks provide an area for vehicles (e.g., trucks, trailers, etc.) to move next to an elevated platform of a building (e.g., a material handling facility) so that cargo can be readily transferred between the vehicle and the building. Some loading docks include equipment such as dock levelers, vehicle restraints, and/or dock doors, any of which may be associated with one or more sensor/monitoring systems.

### BRIEF DESCRIPTION OF THE DRAWINGS

FIG. 1 illustrates an example material handling facility in which teachings disclosed herein may be implemented.

FIG. 2 illustrates the example loading dock of FIG. 1 viewed from an exterior of the material handling facility.

FIG. 3 illustrates the example loading dock of FIG. 1 viewed from an interior of the material handling facility with a trailer parked at the dock.

FIG. 4 illustrates a cross-sectional side view of the example loading dock of FIG. 1 with the associated trailer of FIG. 3.

FIG. 5 illustrates an aerial view of the example material handling facility of FIG. 1.

FIG. 6 is a block diagram of an example implementation of the example main server of FIG. 1.

FIG. 7 illustrates an example layout of the example material handling facility of FIG. 1 as displayed on an example graphical user interface.

FIGS. 8A and 8B illustrate an example movable sizing graphic used to scale the example layout of FIG. 7.

FIG. 9 illustrates an example graphical user interface to facilitate the assignment of a descriptive name to an example controller identified within an asset list of equipment in the example material handling facility of FIG. 1.

FIG. 10 illustrates the placement of example equipment markers on the example layout of FIG. 7.

FIG. 11 illustrates example equipment graphics that display example status of example loading dock equipment.

FIGS. 12-16 are flowcharts representative of example machine readable instructions and/or example operations that may be executed, instantiated, and/or performed by example programmable circuitry to implement the main server of FIG. 6.

FIG. 17 is a block diagram of an example processing platform including programmable circuitry structured to execute, instantiate, and/or perform the example machine readable instructions and/or perform the example operations of FIGS. 12, 13, 14, 15, and/or 16 to implement the main server of FIG. 6.

FIG. 18 is a block diagram of an example implementation of the programmable circuitry of FIG. 17.

FIG. 19 is a block diagram of another example implementation of the programmable circuitry of FIG. 17.

FIG. 20 is a block diagram of an example software/firmware/instructions distribution platform (e.g., one or more servers) to distribute software, instructions, and/or firmware (e.g., corresponding to the example machine readable instructions of FIGS. 12, 13, 14, 15, and/or 16) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

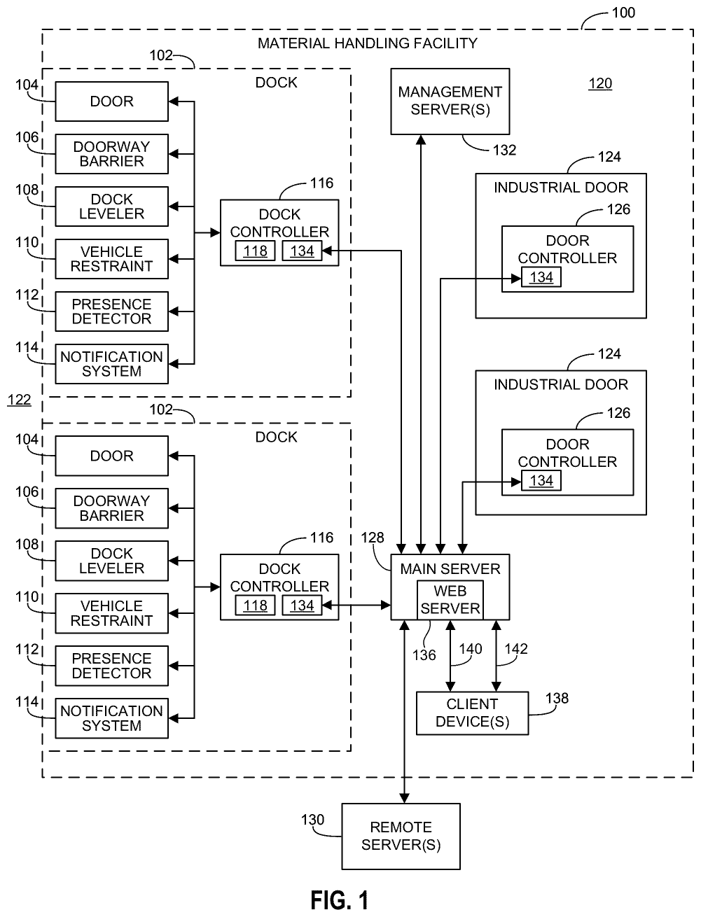

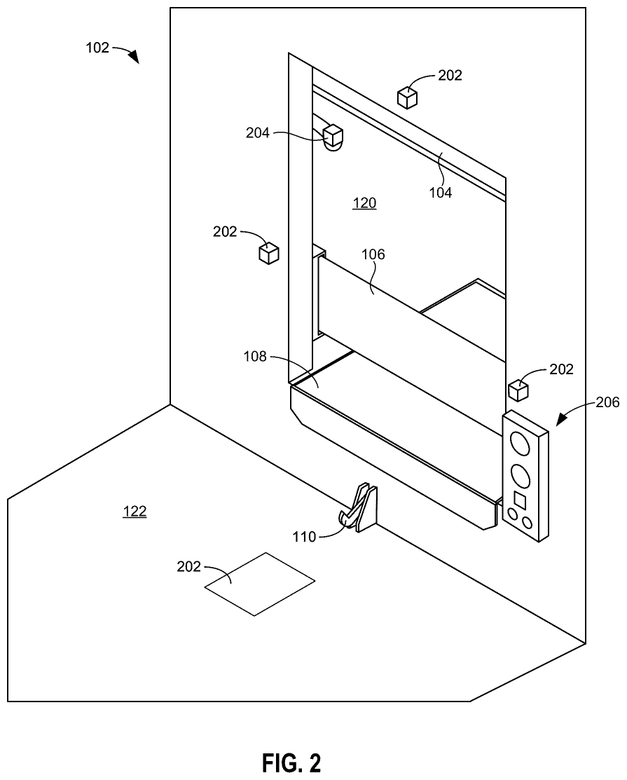

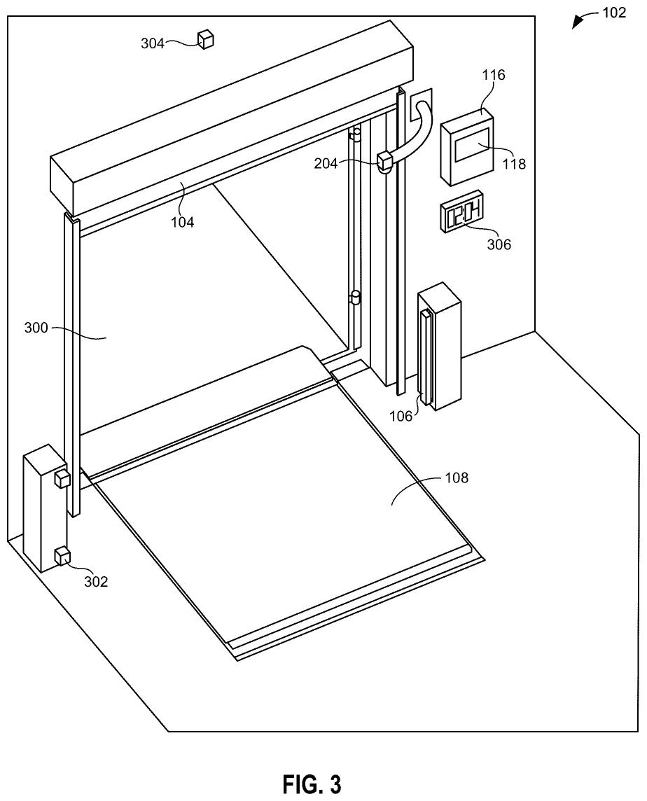

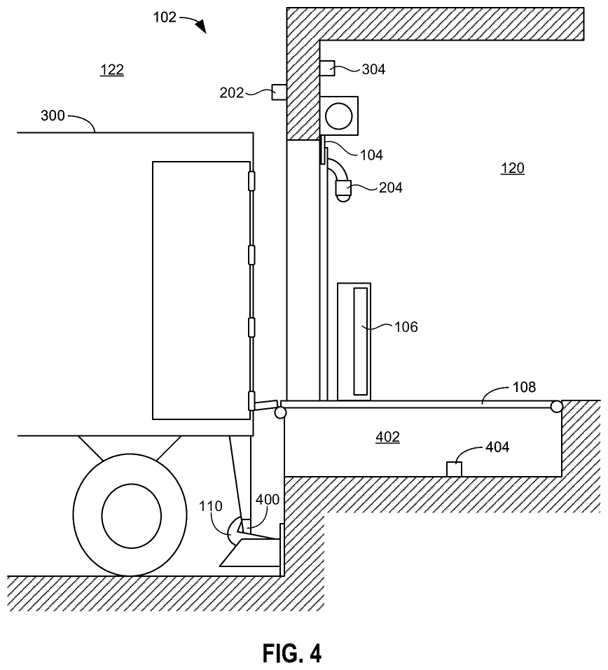

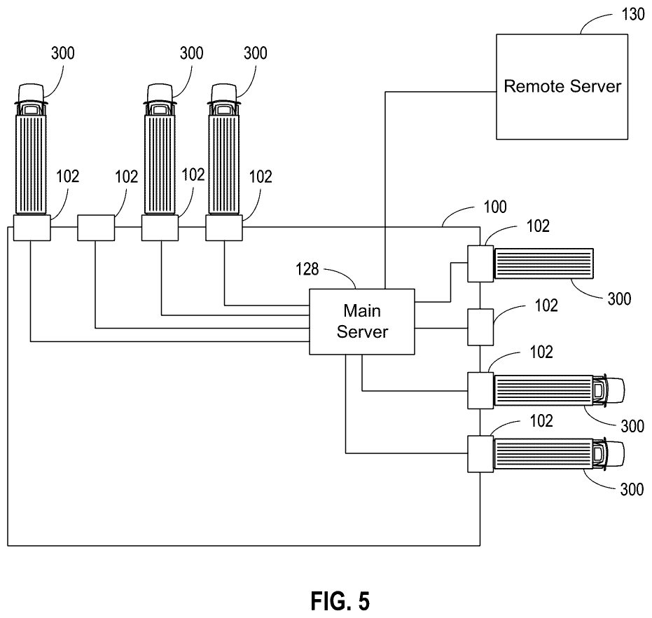

FIG. 1 illustrates an example material handling facility 100 in which teachings disclosed herein may be implemented. The material handling facility 100 may be associated with, for example, a storage warehouse, a distribution center, a manufacturing plant, a retail store, etc. In the illustrated example, the material handling facility 100 includes a plurality of loading docks 102 (two are shown) providing platforms for trucks to back up a trailer or truck bed (both of which are referred to herein as a trailer) to enable the loading and/or unloading of materials between the inside of the trailer and the material handling facility 100. FIG. 2 illustrates an example loading dock 102 viewed from an exterior of the material handling facility 100. FIG. 3 illustrates the example loading dock 102 viewed from an interior of the material handling facility 100 with a trailer 300 parked at the dock 102. FIG. 4 illustrates a cross-sectional side view of the example loading dock 102 with the associated trailer 300. As shown in FIGS. 1-4, the example dock 102 includes a door 104, a doorway barrier 106, a dock leveler 108, a vehicle restraint 110, a presence/motion detector 112, and/or a notification system 114. In some examples, the docks 102 may be associated with and/or include other equipment such as, for example, fans, lights, door seals, shelters, trailer stands, etc. FIG. 5 illustrates an aerial view of the material handling facility 100 including a plurality of example loading docks 102 and a plurality of example trailers 300.

In the illustrated example, each of the docks 102 includes a dock controller 116 to monitor and/or control the operation of the corresponding door 104, the corresponding doorway barrier 106, the corresponding dock leveler 108, the corresponding vehicle restraint 110, the corresponding presence/motion detector 112, the corresponding notification system 114 and/or other equipment associated with the dock. In some examples, the dock controller 116 includes a display screen 118 to display information associated with the components being monitored and/or controlled by the controller 116. The display screen 118 may be a touchscreen in which a user may also input commands and/or instructions to operate the controller and/or access specific information associated with the controller, the dock, or the operations involving the dock. In some examples, the display screen 118 may be incorporated into a different device that is separate from but in communication with the dock controller 116. Although a single controller 116 is shown as controlling all equipment associated with the dock 102, in some examples, each dock 102 may be associated with multiple controllers configured to control and/or monitor different ones of the door 104, the doorway barrier 106, the dock leveler 108, the vehicle restraint 110, the presence/motion detector 112, the notification system 114 and/or other equipment associated with the dock. In other examples, a dock controller 116 may be associated with more than one dock and, thus, able to control more than one aspect and/or function of two or more docks.

The doors 104 associated with the docks 102 are moveable between open and closed positions to selectively unblock or close off a doorway between an interior 120 of the material handling facility 100 and an exterior environment 122. Thus, when the trailer 300 is parked at the dock 102, the door 104 provides access to the trailer when the door 104 is in the open position and prevents such access when in the closed position.

In some examples, the doors 104 are associated with one or more sensors and/or door monitoring systems to facilitate the monitoring and/or control of the operation of the doors 104. For example, one or more door status sensors may monitor and/or detect a status of the door 104 (e.g., whether the door is fully open, fully closed, partially open, partially closed, opening, or closing); one or more impact sensors may monitor and/or detect when the door 104 has been struck (e.g., by a material handling vehicle (e.g., a forklift)); one or more breakaway sensors may monitor and/or detect when the door 104 has been dislodged, forced out, or broken away from the tracks guiding lateral edges of the door panel; one or more photoelectric eyes arranged on either side of the door 104 may monitor and/or detect the passage of a person or object through the doorway when the door is open; one or more motion and/or presence sensors may monitor and/or detect activity in an area proximate the doorway (e.g., in the material handling facility 100 and/or in the trailer 300); one or more radio frequency identification (RFID) sensors may monitor and/or detect the identity of personnel, equipment, and/or material passing through the doorway; one or more temperature sensors may monitor and/or detect the temperature on one or both sides of the door 104; one or more airflow sensors may monitor and/or detect the flow of air passing the door 104 (e.g., air passing through the door when in an open or partially open position and/or air leaking passed the door when in the closed position closed); one or more other environmental sensors may monitor and/or detect pressure, humidity, pollutants, particulates, chemicals, etc.; one or more actuator sensors may monitor and/or detect the energy consumption and/or operation of a door actuator (e.g., a motor) used to open and/or close the door; and one or more image and/or video sensors (e.g., a camera) may be implemented to monitor and/or detect particular states of the dock based on image/video analysis. In some examples, the dock controller 116 receives output signals from these sensors to monitor and/or control the operation of the door 104.

In some examples, the doorway barrier 106 is constructed to provide a barrier that extends across the doorway associated with the door 104. The doorway barrier 106 may block passage through the doorway even when the door 104 is in the open position. The doorway barrier 106 may be used in this manner as a safety precaution when, for example, the door 104 is open but there is no trailer parked at the dock 102 as shown in FIG. 2 or when a trailer at the dock 102 is not restrained. The doorway barrier 106 may also extend across the doorway in front of the door 104 within the interior 120 of the material handling facility 100 when the door 104 is closed to protect the door 104 by reducing the likelihood of material handling equipment colliding with the door 104. In some examples, the doorway barrier 106 is associated with a barrier sensor 302 (FIG. 3) that outputs a signal to the dock controller 116 to indicate a status of the doorway barrier 106 (e.g., whether the barrier is in active use and blocking the doorway (as shown in FIG. 2), stowed away to provide passage through the doorway (as shown in FIGS. 3 and 4), or in some intermediate state). In some examples, the barrier sensor 302 and/or a different sensor detects an impact (e.g., a force) on the barrier 106 that may indicate a collision with the barrier. In the illustrated example of FIGS. 2-4, the doorway barrier 106 is a retractable barrier that is stowed within a support post adjacent one side of the doorway when not in use and spans across the doorway to a second support post when in use. Other types of barriers are possible, for instance, in some examples, the doorway barrier 106 is implemented by a vertically translating gate that includes one or more rails or cross beams that are stored above the doorway when not in use and lowered to cross in front of the doorway when in use. In some examples, such doorway barriers 106 are raised and lowered along tracks that are independent of (e.g., spaced apart from) the tracks that guide the door panel 104 (e.g., vertical tracks located where the support posts shown for the doorway barrier 106 are shown in FIG. 3). In other examples, the vertical doorway barrier 106 can move along the tracks that also guide the door panel 104.

Often, when a truck bed or trailer (e.g., the trailer 300 shown in FIGS. 3 and 4) is parked at the dock 102, there may be a gap between the rear edge of the truck bed or trailer and the outside face of the platform of the dock 102. The dock leveler 108 provides an adjustable bridge to span this gap over which material handling equipment can travel between the interior 120 of the material handling facility 100 and the trailer of the vehicle parked at the dock 102. Furthermore, the dock leveler 108 may be vertically adjustable to act as a ramp that accounts for trailers that have different heights relative to the platform of the dock 102. In some examples, the dock leveler 108 includes one or more sensors to facilitate the monitoring and control of the operation of the dock leveler 108. For example, a leveler sensor may produce an output signal indicative of when the dock leveler 108 is in an active state (extended to bridge the gap between the dock platform and a trailer as shown in FIGS. 3 and 4), an inactive state (when the leveler is in a stored position as shown in FIG. 2), or in some intermediate state. In some examples, a trailer being pulled away from the dock 102 while the dock leveler 108 is in an active state is detected by a sensor such as a limit switch (e.g., detecting the leveler dropping when the extended end is no longer supported by the trailer). In such examples, an output of the limit switch may trigger the dock controller 116 to cause the dock leveler 108 to retract to the stored position of the inactive state.

The vehicle restraint 110 associated with each dock 102 is positioned in the exterior environment 122 to engage some part of the vehicle (e.g., the trailer 300) parked at the dock 102 to reduce inadvertent movement of the vehicle (e.g., by the vehicle shifting as a result of material handling equipment moving around within the trailer and/or by a driver prematurely driving away from the platform). In some examples, the vehicle restraint 110 engages a rear impact guard (e.g., an ICC bar 400 as shown in FIG. 4) of the vehicle to restrain the vehicle. In some examples, the vehicle restraint 110 engages a tire and/or any other suitable portion of the vehicle. In some examples, the vehicle restraint 110 includes one or more sensors to facilitate the monitoring and/or control of the operation of the vehicle restraint 110. For example, a restraint sensor may produce an output signal indicative of when the vehicle restraint 110 is in a locked position (e.g., in position to engage/restrain the vehicle) or an unlocked position (e.g., stored away from the vehicle). Alternatively or in addition, the restraint sensor(s) may produce an output signal indicative of the position of the restraint relative to a reference point and/or the force(s) experienced by the restraint to determine if the restraint is actively engaged/restraining the vehicle or not.

In the illustrated example of FIG. 1, the presence/motion detector 112 represents one or more presence and/or motion detector systems. In some examples, the presence/motion detector 112 includes a presence detector system to detect the presence of the trailer 300 located at the dock 102. The term “trailer” for purposes of discussion related to sensing presence or motion, pertains to a trailer which may or may not be connected and/or disconnected to/from a tractor or alternatively pertains to a vehicle with a cargo bay or platform. In some examples, the presence of the trailer 300 is detected via one or more trailer sensors 202 (FIG. 2) positioned in the exterior environment 122 either on and/or adjacent the building of the material handling facility 100. The trailer sensor(s) 202 may be implemented using any suitable sensors such as, for example, photoelectric eyes, proximity sensors, motion sensors, inductive loop sensors, a light detection and ranging (LIDAR) system, a camera running analytics, etc. In some examples, the presence/motion detector 112 may include a presence detector system to detect the presence of personnel/equipment (e.g., people on foot and/or driving material handling equipment, autonomous vehicles, etc.) within a trailer 300 parked at the loading dock 102 (e.g., loading and/or unloading cargo) or outside the facility on the approach of the dock 102. In some examples, the presence of personnel/equipment within the trailer 300 is detected based on a motion sensor 204 (FIGS. 2-4) facing into the trailer from a position within the material handling facility 100. Additionally or alternatively, the presence/motion detector 112 may include a presence detector system to detect the presence of personnel/equipment/materials on the platform of the dock leveler 108, in the leveler pit 402, and/or otherwise in close proximity to the dock 102. In some examples, the presence of personnel/equipment within the material handling facility 100 in proximity to the dock 102 is detected based on motion sensors 304 (FIGS. 3 and 4) facing the dock leveler 108 and/or surrounding area. Additionally or alternatively, the presence of personnel/equipment/materials may be detected within a leveler pit 402 (FIG. 4) underneath the dock leveler 108 (e.g., for levelers stored in a vertically upright position) based on one or more presence/motion sensors 404 within the leveler pit 402. In addition to detecting the presence of vehicles, personnel, or material handling equipment, any one of the presence/motion systems represented by the presence/motion detector 112 of FIG. 1 may be enabled to determine the movement (e.g., speed, direction, etc.), the position (e.g., proximity, orientation, etc.), the size, the shape, etc. and combinations thereof of vehicles, personnel, equipment, or other things (e.g., product, materials) and may be capable of differentiating between these things.

The notification system 114 of the illustrated example may include multiple separately functioning notification systems that include one or more visual indicators (e.g., lights, display screens, etc.) and/or one or more audible indicators (e.g., horns, bells, sirens, speakers, etc.) to inform personnel near the docks 102 of particular circumstances, warnings, events, and/or other conditions associated with some aspect or status of the dock 102 and/or the vehicle located at the dock. Additionally or alternatively, some of the visual indicators may be lights intended to illuminate and/or improve visibility of areas associated with the docks 102 without indicating any particular circumstance or condition associated with the docks. The visual and/or audible indicators of the notification system 114 may be located within the interior 120 of the material handling facility 100 and/or located in the exterior environment 122 outside of the material handling facility 100 depending on the purpose of the indicators.

In some examples, at least some indicators within the material handling facility are positioned and/or oriented towards the exterior environment 122 (e.g., on the end of the arm associated with the motion sensor 204 shown in FIGS. 2-4) to illuminate, be visible from, and/or heard from within an interior of a trailer parked at the dock 102 when the door 104 is open. Such indicators may provide greater visibility to personnel entering the trailer to load and/or remove cargo. Such indicators may also warn personnel within the trailer of potential safety risks such as the vehicle restraint 110 not being engaged and/or of the presence of people near the platform of the dock 102 that may not be visible from within the trailer. Other indicators within the material handling facility 100 may be positioned and/or oriented to illuminate, be visible from, and/or heard from areas within the interior 120 of the facility (e.g., at the dock platform and/or surrounding area). Some such indicators may serve as warnings of potential safety risks such as, for example, the vehicle restraint 110 not being engaged and/or of the presence of someone in the trailer that may be about to come out unexpectedly. Additionally or alternatively, the indicators may indicate the operational state of equipment associated with the dock 102.

In some examples, the notification system 114 of FIG. 1 includes a timing indicator 306 (FIG. 3) positioned adjacent the door 104 that is visible from within the material handling facility 100 to display a timer indicating how long a trailer has been parked at the dock 102. In this manner, personnel may be informed of how much time is left until detention and/or demurrage charges begin to accrue. In some examples, the timing indicator 306 is implemented via the display screen 118 associated with the dock controller 116. In some examples, the timing indicator 306 may count down instead of counting up. In some examples, the timing indicator 306 may change appearance (e.g., change color, begin flashing, etc.) and/or another indicator may be activated when the timing indicator reaches a threshold to indicate to personnel the near expiration of time related to a particular operational constraint (e.g., the need to quickly finish loading and/or unloading the trailer). In some examples, the timing indicator 306 may indicate (e.g., based on a color, flashing, etc.) a priority for loading and/or unloading a trailer at the corresponding dock 102 relative to the loading and/or unloading of other trailers at other docks 102. In some such examples, the prioritization may be based on predicted time allocation and/or predicted cost incursion across multiple docks 102 of the material handling facility 100 in light of available operational resources (e.g., personnel on hand, available material handling equipment, pick status, cross dock order status, etc.). Although the timing indicator 306 is shown as being distinct and spaced apart from the controller 116 in the illustrated examples, in other examples, the controller 116 includes the timing indicator 306.

In some examples, one or more indicators are positioned on the outside of the material handling facility 100 to illuminate, be visible from, and/or heard from areas external to the docks 102. In some examples, such indicators may be lights that illuminate the area to provide greater visibility for people in the exterior environment 122 (e.g., a driver backing a trailer up to the dock 102). Additionally or alternatively, in some examples, the indicators may be lights that provide warnings and/or guidance to people in the exterior environment 122. For example, as shown in FIG. 2, light indicators 206 on the exterior of the material handling facility 100 include a stop (red) and go (green) light to direct a truck driver when a trailer (e.g., the trailer 300 of FIGS. 3 and 4) may be backed into the area adjacent the dock 102 and/or when the trailer may be pulled away from the dock 102. In some examples, light and/or audible indicators can be used to indicate to a driver when the vehicle restraint 110 is in override (e.g., manually disabled or otherwise designated based on human input that the vehicle restraint 110 is not being used in a given situation because, for example, the shape and/or construction of the trailer prevents the vehicle restraint 110 from engaging and/or restraining the trailer), dock equipment is undergoing maintenance, or there is someone/something in or near the path of the trailer, etc. These conditions may be communicated via separate indicators, utilizing different states of a common indicator (color/tone change, flashing/sounding pattern, etc.) or combinations thereof. Further, in some examples, indicators associated with the dock 102 include lights and/or audible alarms indicating to people standing near the dock approach when a truck is backing in.

In some examples, the dock controller 116 controls the different indicators associated with the notification system 114 based on one or more of the signals received from the various sensors associated with the door 104, the doorway barrier 106, the dock leveler 108, the vehicle restraint 110, and/or the presence detector 112. For instance, in some such examples, the dock controller 116 causes the light indicators 206 to provide a stop light (e.g., a red light) whenever the restraint signal indicates that the vehicle restraint 110 is active and engaged with the trailer. As another example, if the door sensor indicates the door 104 is opened when the presence detector 112 fails to detect a trailer parked at the dock 102, there is a risk that the open door may lead to a drop-off of the dock platform. Accordingly, in some such examples, the dock controller 116 may turn on a warning indicator to caution nearby individuals of the exposed drop. Additionally or alternatively, the dock controller 116 causes the door 104 to be closed and/or for a doorway barrier 106 (e.g., a vertically translating gate that is powered by a motor) to be moved into position across the doorway to mitigate the hazard of the detected drop-off. However, in some such examples, the dock controller 116 may not trigger the warning indicator when the barrier sensor 302 provides a signal indicating the doorway barrier 106 is in active use to block passage through the opened doorway. Thus, different signals output from different ones of the various sensors may be used in combination to trigger a change in the activation or state of indicators associated with the notification system 114 to provide warnings, notifications, and/or guidance to people in areas associated with the dock 102.

While the material handling facility 100 includes the docks 102 with various components and/or systems to facilitate the transfer of goods between a trailer and the material handling facility 100, the material handling facility 100 of FIG. 1 also includes other components and/or systems that facilitate the handling, movement, and/or storage of goods within the interior 120 of the material handling facility 100. In some examples, these components and/or systems may operate substantially independent of one another with separate controllers to monitor and/or control their operation. In particular, as shown in FIG. 1, the material handling facility 100 includes one or more industrial doors 124 (two are shown) that are powered to selectively block and unblock doorways and/or other passageways between different locations (e.g., rooms and/or other areas) within the material handling facility 100.

In the illustrated example, each door 124 includes a corresponding door controller 126 to control the operation of the door 124. In some examples, the industrial doors 124 also include sensors similar to or the same as those described above (for the doors 104 at the loading docks 102) to enable the door controllers 126 to monitor and/or control the internal doors 124. For example, such doors 124 may include one or more door status sensors that indicate a status of the door 124 (e.g., open, closed, opening, closing, etc.); one or more impact sensors that monitor and/or detect when the door has been impacted, such as when a material handling vehicle has struck the door 124; one or more sensors, such as photoelectric eyes that monitor and/or detect the passage of a person or object through a doorway associated with the door 124; one or more motion and/or presence sensors that monitor and/or detect activity in an area proximate the doorway (e.g., on one or both sides of the doorway); one or more RFID sensors that monitor and/or detect the identity of personnel, equipment, and/or material passing through the doorway; one or more temperature sensors that monitor and/or detect the temperature on one or both sides of the door 124; one or more other environmental sensors that monitor and/or detect pressure, humidity, pollutants, particulates, chemicals, etc.; one or more airflow sensors that monitor and/or detect the flow of air passing the door 124 (e.g., air passing the door 124 when in an open or partially open position and/or air leaking passed the door 124 when in the closed position); and one or more actuator sensors that monitor and/or detect the energy consumption and/or operation of a door actuator (e.g., a motor) used to open and/or close the door 124. Additionally or alternatively, in some examples the door 124 includes one or more breakaway sensors to detect a breakaway event. As used herein, a breakaway event is when a door panel of an example door 124 is forced out of tracks guiding lateral edges of the door panel. Typically, breakaway events are caused by an impact with the door panel by a relatively large object (e.g., a forklift). However, breakaway events can be caused by a pressure blowout. In some examples, the door controller 126 includes and/or is communicatively coupled to a local display screen similar to the display screen 118 of the dock controller 116.

In some examples, how the door controller 126 uses signals output by such sensors may depend on the location and/or intended use of the associated door 124. For example, one or more doors 124 may provide access to a freezer room. In such examples, the associated door controller 126 may monitor a feedback signal provided by a temperature sensor to ensure the temperature on the freezer side of the room remains at or below a temperature set point. Additionally or alternatively, the door controller 126 for a freezer door may monitor how frequently and/or how long the door is opened (based on feedback from the door status sensor) and generate alerts when the frequency or duration of the door being open exceeds corresponding thresholds. In other examples, one or more doors 124 may be used to control access to a cleanroom with a relatively low level of pollutants. In some such examples, the door controller 126 may monitor feedback signals from one or more airflow and/or pressure sensors to ensure the amount of airflow (potentially leading to the spread of contaminants) is maintained at or below a suitable threshold or that a certain pressure differential is maintained across the doorway. In some examples, separate doors (e.g., the industrial doors 124 and/or the dock doors 104) may be configured according to an interlock relationship such that the operation of one door is conditioned on the state or operation of a second door (e.g., only one of two doors may be opened at any given point in time). In such examples, signals from sensors monitoring the operation of each door may be provided to separate door controllers 126 (and/or dock controllers 116 controlling doors at a corresponding dock 102) associated with each door (or a single controller 116, 126 that controls both doors).

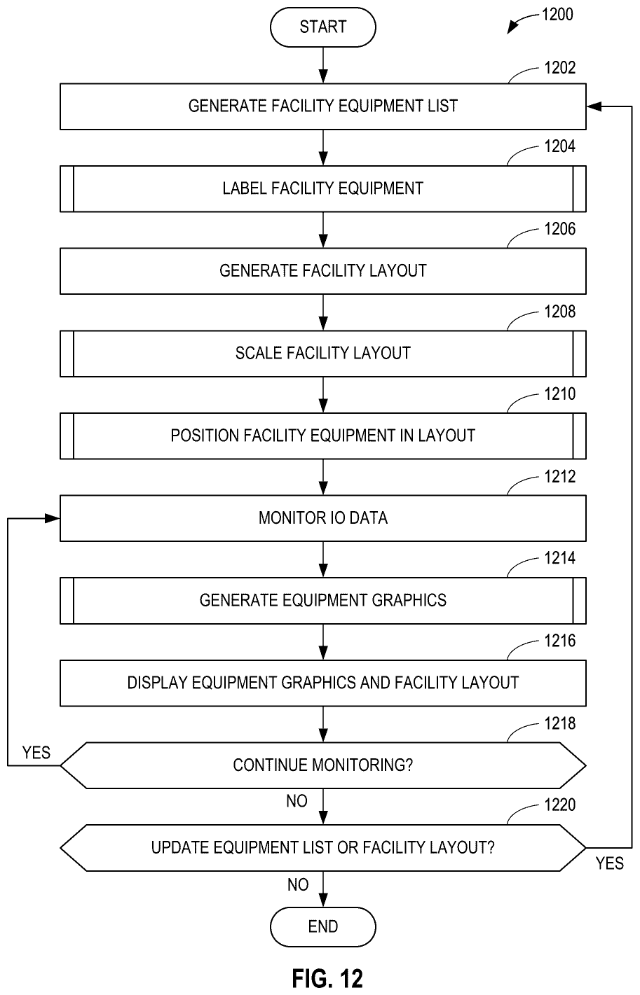

In the illustrated example of FIG. 1, each of the dock controllers 116 associated with the different docks 102 and the door controllers 126 associated with internal industrial doors 124 communicates with a main server 128. More particularly, in some examples, the dock controllers 116 and the door controllers 126 transmit values corresponding to the operational and/or state parameters configured in the respective controllers 116, 126 and/or feedback signals collected from any sensors associated with the respective controllers. In this manner, the main server 128 aggregates all available data associated with the various and separate systems in the material handling facility 100 into one place. The aggregation of data from the disparate sources enables the main server 128 to analyze and/or integrate the controller data to identify relationships that would not otherwise be possible to identify. As described more fully below, in some examples, the main server 128 organizes the aggregated controller data for presentation to end users via one or more dashboards or graphical user interfaces (GUIs) directed to particular interests of the end users. The graphical user interfaces may be presented by one or more web pages, apps, applets, applications, etc. In some examples, the graphical user interfaces may be configurable to provide notifications and/or alerts when particular events are detected based on the values of a combination of different parameters monitored by one or more of the controllers 116, 126. Further details regarding the implementation of the example main server 128 are provided below in connection with FIGS. 12-16. Additionally or alternatively, in some examples, the main server 128 may transmit information back to the controllers 116, 126. In some such examples, information transmitted to the controllers is passive in that it does not affect the operation of the components controlled by the controllers. In such examples, the information may be provided to be displayed on a local display screen (e.g., the display screen 118 of the dock controller 116 shown in FIG. 3 and/or a similar local display screen associated with one of the door controllers 126) to be referenced by personnel positioned near the controllers. In other examples, the information transmitted to the controllers from the main server 128 may be active in that it includes commands causing the controllers to implement certain operations. Although the main server 128 is shown as being located within the material handling facility 100 in the illustrated example, in other examples, the main server 128 may be remotely located away from the material handling facility 100. In some examples, the main server 128 may be integrated with and/or implemented by one of the dock controllers 116. In some examples, the main server 128 may be located in the cloud (e.g., may be a server provided by a cloud provider).

In some examples, the graphical user interfaces generated based on information aggregated by the main server 128 may be configurable to provide substantially real-time (e.g., less than a 5 second delay, less than 1 second delay) information regarding the configurations, operations, and/or current states of one or more of the docks 102 and/or doors 124. In some examples, the graphical user interfaces are configured to display such information in conjunction with (e.g., on top of) a map of the material handling facility 100 (e.g., a facility layout) to indicate the location of equipment within the facility from which the configuration, operation, and/or state information is obtained or otherwise associated.

In the illustrated example of FIG. 1, the main server 128 communicates with one or more remote server(s) 130 that are not located at the material handling facility 100. In some examples, the remote server(s) 130 correspond to additional servers, comparable to the main server 128, that are located at other material handling facilities and/or other locations associated with the business enterprise operating the material handling facility 100 of FIG. 1. Additionally or alternatively, in some examples, the remote server(s) 130 may correspond to a server maintained by a manufacturer of equipment associated with one or more of the dock controllers 116 and/or the door controllers 126. For example, the remote server 130 may provide equipment warranty information, equipment version and/or update information, equipment installation dates, records of technician and/or service calls, etc. In other examples, the remote server 130 may be located in the cloud (e.g., may be a server provided by a cloud provider).

In the illustrated example of FIG. 1, the material handling facility 100 includes one or more management server(s) 132 that facilitate the management of various aspects of the equipment assets and/or working operations of the material handling facility 100. In some examples, the management server(s) 132 communicate with the main server 128 via a bus, local area network (LAN), and/or a wide area network (e.g., the Internet). The example management server(s) 132 may include a dock/yard management system, an inventory control system, a video management system (VMS), a warehouse management system (WMS), an enterprise resource planning (ERP) system, a building management system (BMS), an asset management system (AMS), etc. Additionally or alternatively, in some examples, one or more of the management servers 132 may be combined with and/or implemented by the main server 128.

For purposes of explanation, the data reported to the main server 128 from the different controllers 116, 126 of FIG. 1 is referred to herein as IO (input/output) data because it includes the inputs and outputs monitored and/or provided by the respective controllers. The IO data is also referred to herein as sensor feedback data because the IO data is based on feedback from sensors collected by the different controllers 116, 126. As used herein, sensors associated with a controller 116, 126 include buttons, touchscreen icons, and/or other user interfaces associated with the controllers 116, 126 that can be pressed or otherwise interacted with by users to direct operations of the controllers 116, 126. In some examples, the IO data (sensor feedback data) includes a timing and/or duration that a button is pressed and/or an icon is selected by a user. In the illustrated example, the IO data (sensor feedback data) collected by the main server 128 is transmitted from the controllers 116, 126 over a wireless mesh network (other network types could also be used (e.g., wired, or wireless non-mesh)). Accordingly, as shown in the illustrated example of FIG. 1, each of the controllers 116, 126 is equipped with an IO communication board 134 that includes a wireless transceiver (e.g., a radio) to transmit the IO data according to any suitable communications protocol. In some examples, the IO boards of the controllers 116, 126 transmit IO data directly (e.g., without a mesh network) to a receiver associated with the main server 128. In other examples, the IO data from one controller may be transmitted to the main server 128 indirectly via the IO communication board 134 in a different controller and/or via any other device or component capable of communicating on the mesh network (e.g., one or more gateways, relays, repeaters, etc.). In some examples, the IO communication board 134 is constructed to communicate with the main server 128 over a cellular network. Additionally or alternatively, in some examples, the IO communication board 134 is constructed to communicate with a Wi-Fi network that is communicatively coupled to the main server 128 via the Internet.

In some examples, the IO boards of the controllers 116, 126 are implemented with a reusable firmware module that converts and normalizes data collected by the different controllers into a common format corresponding to the particular communication protocol. The reusable nature of the firmware enables the firmware to be embedded into existing products so that they may be modified for integration in the monitoring system of the main server 128. Enabling each of the controllers 116, 126 to transmit data in a common format according to a single communications protocol enables the main server 128 to directly integrate and associate data collected from different types of controllers regardless of the original source of the data and/or nature and/or type of sensors used to generate such data.

In some examples, transmissions from the controllers 116, 126 reporting IO data include device identification information that includes an identifier, name and/or type for the device or controller sending the message as well as an address for the device on the network. The device identification information enables the main server 128 to determine the source of the message (e.g., the controller that sent the message). In some examples, the IO data includes values of particular IO parameters monitored and/or generated by the controller. In some examples, the values of the IO parameters correspond to measured outputs of sensors monitored by the corresponding controller (e.g., an output of a door sensor indicating whether the door 104 is open or closed). In other examples, the values of the IO parameters are not directly measured or sensed but are derived based on one or more measured values (e.g., deriving the transitional state of the door 104 (e.g., opening or closing) based on the last state of the door sensor and a signal from an actuator sensor indicating the door actuator is moving the door). Additionally or alternatively, the IO parameters are derived based on the sequence, duration, and/or timing of user inputs (e.g., when, how long, and/or in what order a button is pressed, etc.).

As mentioned above, the main server 128 serves as a central hub to aggregate and/or integrate data associated with the disparate systems (e.g., different docks 102 and/or industrial doors 124) operating throughout the material handling facility 100. In some examples, the main server 128 includes, corresponds to, and/or is associated with a web server 136 that hosts one or more web pages accessible by a user via a client device 138. Client devices 138 may be any suitable computing device with a browser to access the web pages hosted by the web server 136. Thus, the client devices 138 may correspond to one or more operator stations located at the material handling facility 100 (e.g., in the logistics office of the facility). In some examples, the client devices may be portable devices (e.g., tablets, smartphones, etc.) carried by personnel throughout the material handling facility 100 and/or remotely away from the facility. Further, some client devices 138 may be portable devices used by truck drivers hauling trailers to or from the material handling facility 100 and/or yard jockeys who reposition trailers at the docks 102 and/or within the yard of the material handling facility 100.

The different web pages may include different graphical user interfaces designed to present different types of information in a format that is easy to understand and facilitates a user in recognizing the relationship of data collected from different sources within the material handling facility 100. In some examples, the main server 128 automatically causes the one or more of the web pages to be updated through web-based communications 140 any time new data is collected that is relevant to the particular web pages. Further, in some examples, the web pages are designed to receive user input that is provided back to the main server 128. In some examples, web page updates are implemented based on pull requests from the client devices requesting updated information. Additionally or alternatively, in some examples, updates may be pushed to web pages actively opened by specific client devices for dynamic updating through the use of push requests. In some examples, user input received at one web page may be pushed to other web pages that are displaying information relating to the user input (e.g., other web pages being accessed by other client devices 138). Although graphical user interfaces are disclosed in connection with web pages herein, the graphical user interfaces may be presented using something other than web pages (e.g., via an app, applet, application, etc.). In some examples, the graphical user interfaces are provided via a display associated with the example notification system 114 that is local to a particular dock 102 as discussed above in connection with FIG. 1.

In some examples, the main server 128 analyzes information provided from the separate systems within the material handling facility 100 to identify circumstances, conditions, and/or events (collectively referred to herein as events) that may need a response or other resolution. In some examples, the identification of such events is based on configurable rules that depend on feedback (e.g., particular IO data) from multiple different ones of the controllers 116, 126. In some examples, the main server 128 triggers particular responses based on the detection of particular events (e.g., when the conditions of associated event rules are satisfied). In some examples, the response may include providing information and/or instructions back to one or more of the controllers 116, 126 to cause such controllers to initiate some action in the equipment associated with the corresponding controller (e.g., open or close a door; switch the status of an indicator light; etc.). In some examples, the main server 128 may respond to particular events by generating alerts, warnings, notifications, log entries, and/or reports (collectively referred to herein as notifications) that are provided to one or more client devices 138. In some examples, such notifications may be provided via the web communications 140 as the web pages are updated. Additionally or alternatively, the main server 128 may provide notifications to the client devices 138 independent of the web server 136 using other forms of network communications 142 such as, for example, email messages, SMS (Short Message Service) messages, push notifications, etc. Additionally or alternatively, the main server 128 may transmit notifications for rendering via a local display screen (e.g., the display screen 118) associated with one of the controllers 116, 126 throughout the material handling facility 100. In this manner, such notifications provide information to personnel located in proximity with the same controllers that reported information to the main server 128 that was used to generate the notifications.

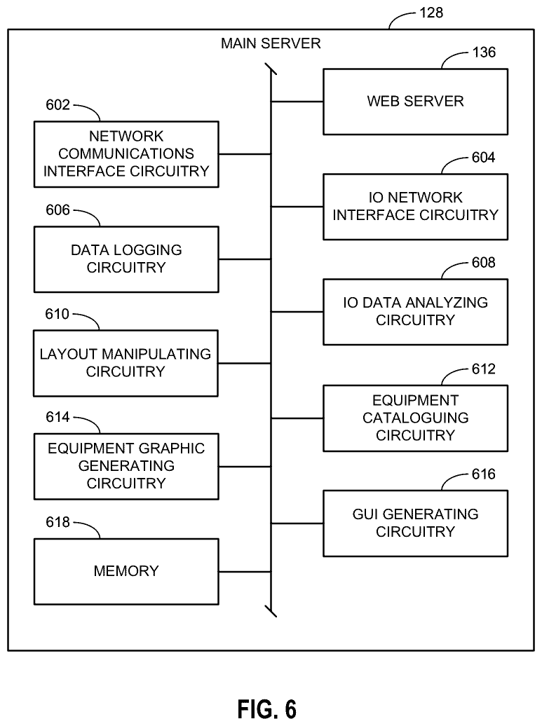

FIG. 6 is a block diagram of an example implementation of the main server 128 of FIG. 1 to aggregate data (e.g., IO data) from various sensors and/or controllers (e.g., the controllers 116, 126) associated with different equipment (e.g., the docks 102 and/or the doors 124) of a material handling facility (e.g., the facility 100) and to generate graphical user interfaces (GUIs) based on such aggregated data. The main server 128 of FIG. 6 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the main server 128 of FIG. 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers. As shown in FIG. 6, the example main server 128 includes the web server 136. However, as noted above, in some examples, the web server 136 may be implemented separate from the main server 128. Alternatively, the web server 136 may correspond to the main server 128. In other examples, the web server 136 is implemented as software by the main server 128. The example main server 128 also includes, as shown in FIG. 6, example network communications interface circuitry 602, example IO network interface circuitry 604, example data logging circuitry 606, example IO data analyzing circuitry 608, example layout manipulating circuitry 610, example equipment cataloguing circuitry 612, example equipment graphic generating circuitry 614, example GUI generating circuitry 616, and example memory 618.

The example network communications interface circuitry 602 of FIG. 6 enables communications with the client devices 138 independent of the web server 136. For instance, the network communications interface circuitry 602 may send out email messages and/or SMS messages to one or more client devices 138. Additionally, in some examples, the network communications interface circuitry 602 may send data to and/or receive data from the local management server(s) 132 and/or the remote server(s) 130. In some examples, data received from the servers 130, 132 is stored in the example memory 618. In some examples, the network communications interface circuitry 602 is instantiated by programmable circuitry executing network communications interface instructions and/or configured to perform operations such as those represented by the flowcharts of FIGS. 12, 13 and 16.

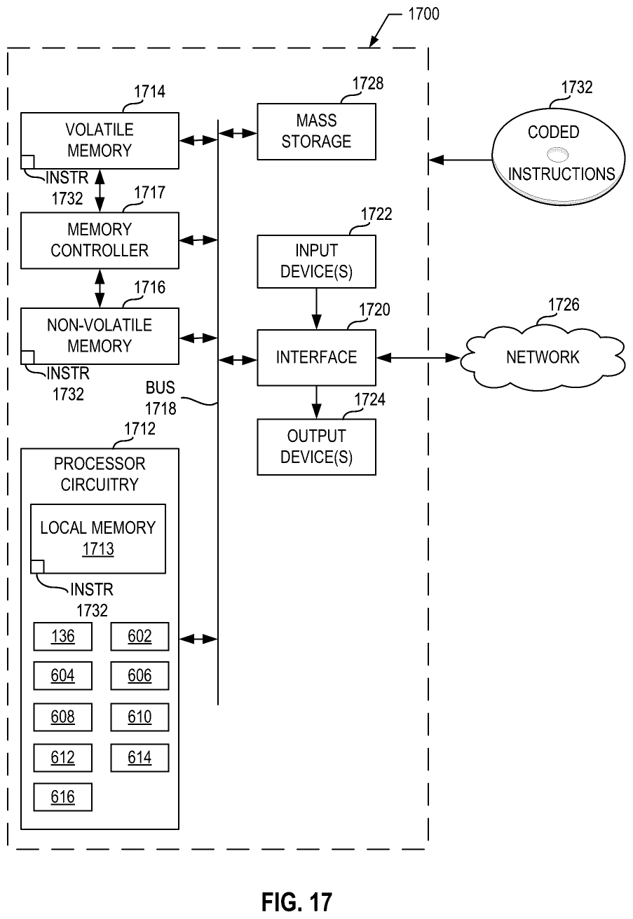

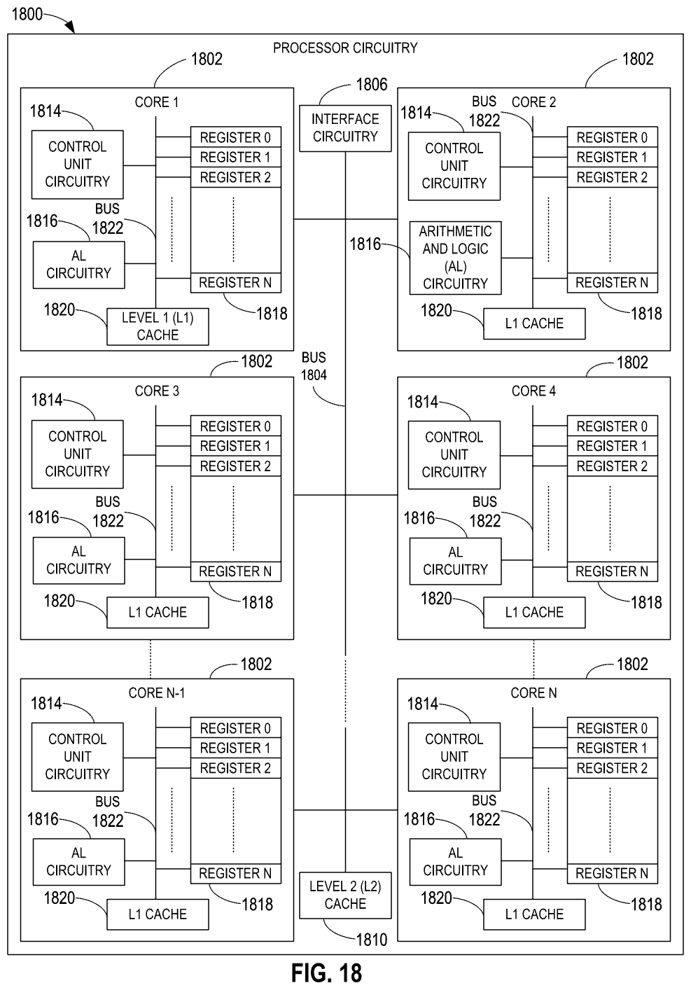

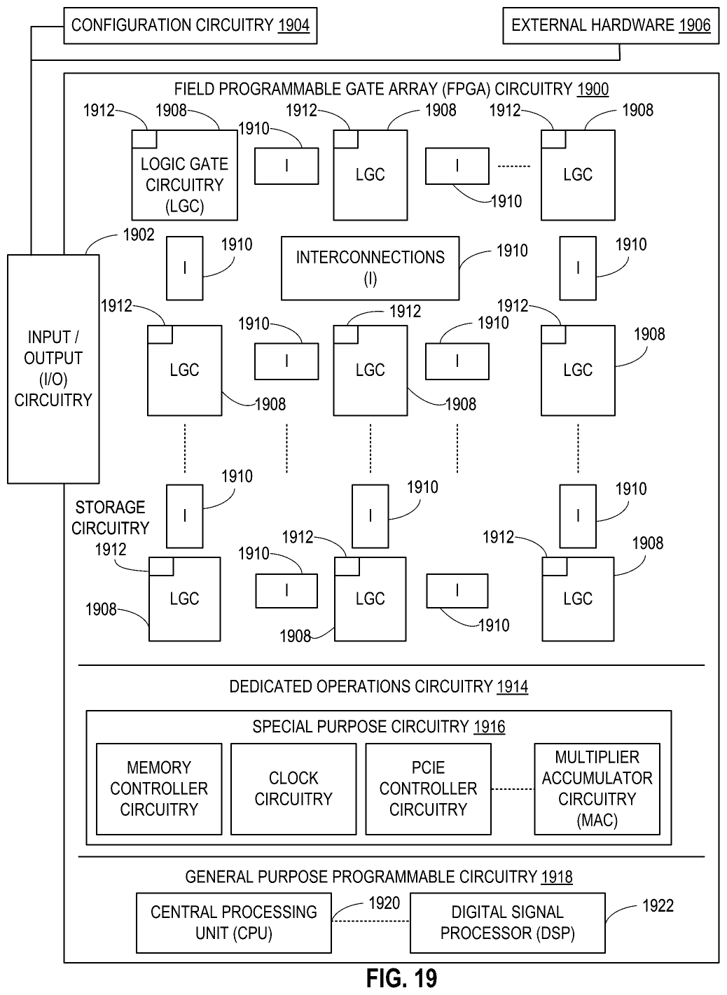

In some examples, the main server 128 includes means for communicating with remote devices (e.g., the client devices 138, the local management server(s) 132, and/or the remote server(s) 130). For example, the means for communicating may be implemented by network communications interface circuitry 602. In some examples, the network communications interface circuitry 602 may be instantiated by programmable circuitry such as the example programmable circuitry 1712 of FIG. 17. For instance, the network communications interface circuitry 602 may be instantiated by the example microprocessor 1800 of FIG. 18 executing associated machine executable instructions. In some examples, network communications interface circuitry 602 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the network communications interface circuitry 602 may be instantiated by any other combination of hardware, software, and/or firmware. For example, the network communications interface circuitry 602 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example IO network interface circuitry 604 of FIG. 6 enables communications with the dock controllers 116 and the door controllers 126. That is, the IO network interface circuitry 604 receives IO data (e.g., sensor feedback data, equipment status data, etc.), collected by the controllers 116, 126 and/or any other type of IO data reported by the controllers 116, 126. In some examples, the IO network interface circuitry 604 receives device identification information (e.g., serial numbers, IP addresses, addresses, unique IDs, etc.) from the controllers 116, 126. IO data and/or device identification information may be aggregated and stored in the memory 618 for subsequent analysis and/or processing. Additionally or alternatively, in some examples, the IO network interface circuitry 604 transmits instructions, commands, and/or other types of information to the controllers 116, 126. In some examples, the IO network interface circuitry 604 is instantiated by programmable circuitry executing IO network interface instructions and/or configured to perform operations such as those represented by the flowcharts of FIGS. 12, 13, and 16.

In some examples, the main server 128 includes means for communicating with equipment (e.g., the controllers 116, 126) in the material handling facility 100. For example, the means for communicating may be implemented by IO network interface circuitry 604. In some examples, the IO network interface circuitry 604 may be instantiated by programmable circuitry such as the example programmable circuitry 1712 of FIG. 17. For instance, the IO network interface circuitry 604 may be instantiated by the example microprocessor 1800 of FIG. 18 executing machine executable instructions such as those implemented by at least blocks 1202, 1212, 1306, 1602 of FIGS. 12, 13, and 16. In some examples, IO network interface circuitry 604 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the IO network interface circuitry 604 may be instantiated by any other combination of hardware, software, and/or firmware. For example, the IO network interface circuitry 604 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

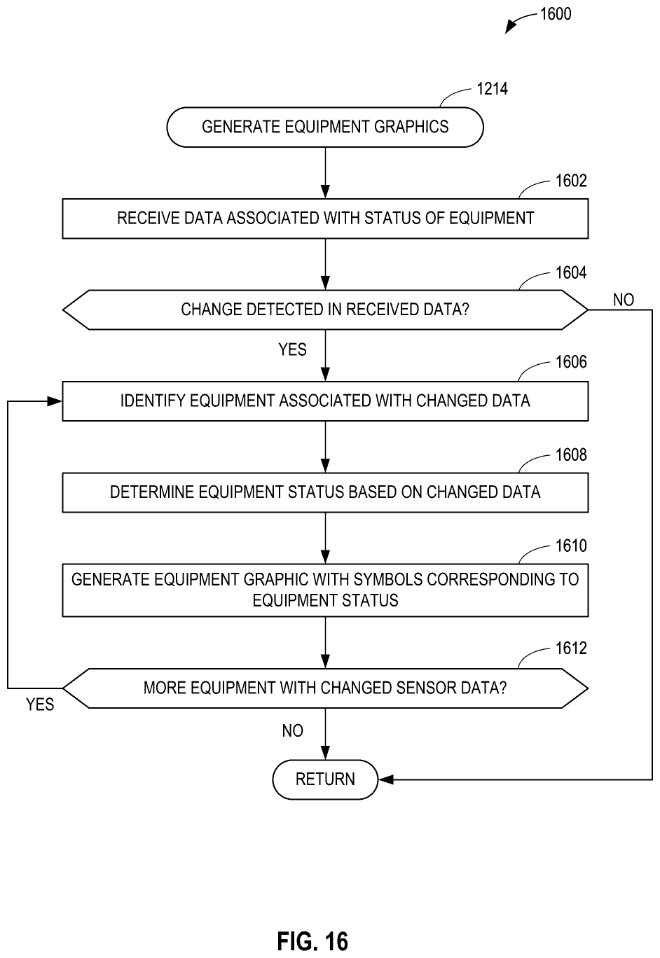

The example data logging circuitry 606 logs the IO data (e.g., sensor feedback data, equipment status data, etc.) in the memory 618. The IO data in the memory 618 can later be used by the IO data analyzing circuitry 608 and the equipment graphic generating circuitry 614. In some examples, the data logging circuitry 606 is instantiated by programmable circuitry executing data logging instructions and/or configured to perform operations such as those represented by the flowcharts of FIGS. 12 and 16.

In some examples, the main server 128 includes means for logging data (e.g., IO data, sensor feedback data, equipment status data, etc.) in a data store (e.g., in the example memory 618). For example, the means for logging may be implemented by data logging circuitry 606. In some examples, the data logging circuitry 606 may be instantiated by programmable circuitry such as the example programmable circuitry 1712 of FIG. 17. For instance, the data logging circuitry 606 may be instantiated by the example microprocessor 1800 of FIG. 18 executing machine executable instructions such as those implemented by at least blocks 1202, 1212, 1602, 1604 of FIGS. 12 and 16. In some examples, data logging circuitry 606 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the data logging circuitry 606 may be instantiated by any other combination of hardware, software, and/or firmware. For example, the data logging circuitry 606 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example IO data analyzing circuitry 608 analyzes feedback collected from sensors associated with the equipment at the docks 102 and/or the industrial doors 124 to determine the status and/or condition of the equipment and provide suitable commands and/or instructions to the equipment based on the reported status and/or condition of the equipment. In some examples, the IO data analyzing circuitry 608 analyzes IO data to determine if a change in status of the equipment at the docks 102 and/or the industrial doors 124 has recently occurred (e.g., since the last time a change in status was determined). Additionally, in some examples, the IO data analyzing circuitry 608 analyzes and/or compares IO data aggregated from different dock controllers 116 associated with different docks 102 and/or different door controllers 126 associated with different industrial doors 124. In some examples, the IO data analyzing circuitry 608 is instantiated by programmable circuitry executing IO data analyzing instructions and/or configured to perform operations such as those represented by the flowcharts of FIGS. 12, 13, and 16.

In some examples, the main server 128 includes means for analyzing IO data. For example, the means for analyzing may be implemented by IO data analyzing circuitry 608. In some examples, the IO data analyzing circuitry 608 may be instantiated by programmable circuitry such as the example programmable circuitry 1712 of FIG. 17. For instance, the IO data analyzing circuitry 608 may be instantiated by the example microprocessor 1800 of FIG. 18 executing machine executable instructions such as those implemented by at least blocks 1202, 1212, 1214, 1306, 1604, 1606, and 1608 of FIGS. 12, 13, and 16. In some examples, IO data analyzing circuitry 608 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the IO data analyzing circuitry 608 may be instantiated by any other combination of hardware, software, and/or firmware. For example, the IO data analyzing circuitry 608 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example layout manipulating circuitry 610 of FIG. 6 receives, manipulates, pre-processes, and/or generates an example layout of the example material handling facility 100 of FIG. 1 to prepare the layout for use in graphical user interfaces (GUIs) discussed further below. The layout is a map or other representation (e.g., facility layout, facility map, aerial view, birds eye view, picture, drawing, sketch, etc.) of the material handling facility 100 that illustrates a spatial relationship between various physical or architectural features in the material handling facility (e.g., the docks 102 and/or the doors 124). In some examples, the layout manipulating circuitry 610 receives the layout in the form of image data (e.g., .jpg file, .gif file, .pdf file, etc.). In some examples, the layout manipulating circuitry 610 receives the layout in a computer aided design (CAD) format. In some examples, the layout manipulating circuitry 610 converts the layout into a second format (e.g., a scalable vector graphics (SVG) format) for easier use and scaling as discussed below. In other examples, the layout manipulating circuitry 610 receives a layout that is drawn or otherwise input via the GUI generating circuitry 616 from a user. The layout manipulating circuitry 610 can manipulate the layout to display the layout at different sizes and/or positions.

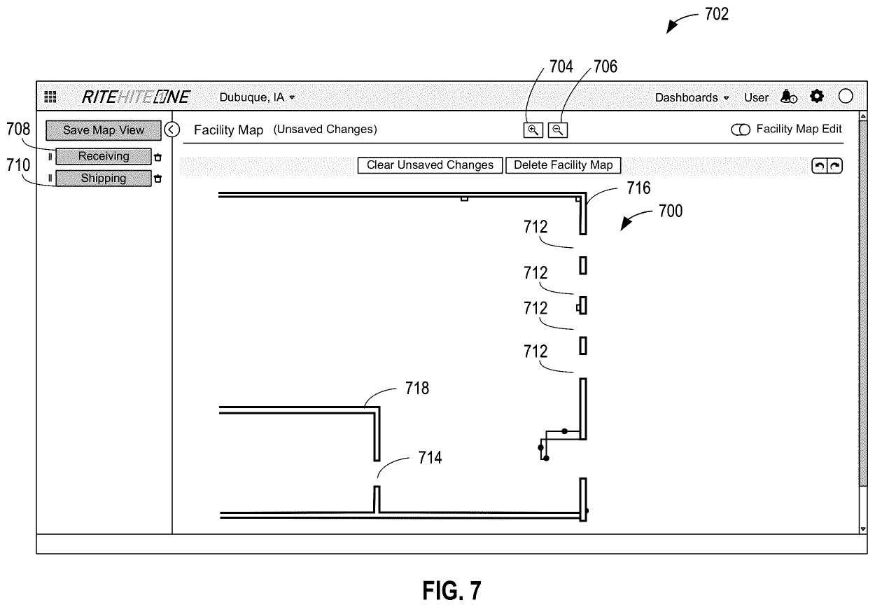

FIG. 7 illustrates an example layout 700 of the example material handling facility 100 of FIG. 1 as displayed on an example Graphical User Interface (GUI) 702. The layout 700 is manipulated (e.g., zoomed in, zoomed out, enlarged, panned, rotated, etc.) by the layout manipulating circuitry 610 based on user input received by the GUI generating circuitry 616 through the GUI 702. In some examples, the layout 700 can be sized (e.g., zoomed in or out) based on pressing or otherwise selecting zoom icons (e.g., icons 704, 706). In other examples, the layout 700 can be manipulated using other input methods (e.g., mouse scroll wheel, keyboard entry, etc.). In some examples, a particular position and size of the layout can be configured by a user and saved as a named shortcut, such as a receiving shortcut 708 (associated to a portion of the facility 100 where docks are located at which shipments or cargo are received) and a shipping shortcut 710 (associated to a different portion of the facility 100 where docks are located at which materials are shipped out). The shortcuts 708, 710 allow for quick reference to specific areas of the facility 100 represented in the layout without needing to manipulate the layout 700 presented on the GUI 702 with a series of user inputs. In other words, the shortcuts 708, 710 allow the GUI generating circuitry 616 to switch between presenting a first portion of the layout (e.g., the entire layout, a larger portion of the layout, etc.) and a second portion of the layout (e.g., a shipping portion of the layout, a smaller portion of the layout, a specific dock, etc.). The GUI generating circuitry 616 can generate shortcuts that store a size, a location, and an orientation used by the layout manipulating circuitry 610 to display the layout 700 on the GUI 702. The layout 700 includes dock sections 712 (e.g., dock doorways) that correspond to docks 102 of the material handling facility 100 in FIG. 1. In some examples, the layout 700 includes industrial door sections 714 (e.g., industrial door doorways) that correspond to industrial doors 124 of the material handling facility 100 in FIG. 1. In some examples, the dock sections 712 and the industrial door sections 714 are represented in the layout as open sections (e.g., doorways, passageways) of the outer wall 716 and an inner wall 718, respectively. In other examples, the dock sections 712 and/or the industrial door sections 714 can be depicted with lines or symbols denoting the presence of a dock and/or industrial door. The particular way in which the dock sections 712 and/or industrial door sections 714 appear may depend on the nature and contents of the file (e.g., image) initially provided to the layout manipulating circuitry 610 to serve as the basis for the layout 700.

In some examples, the layout manipulating circuitry 610 defines a scaling factor to the layout to correlate a size of the layout with the sizes of other graphical components generated by the equipment graphic generating circuitry 614 and the GUI generating circuitry 616. More particularly, as further detailed below, the equipment graphic generating circuitry 614 and the GUI generating circuitry 616 may produce graphics associated with equipment (e.g., the docks 102 and the doors 124 of FIG. 1) and its associated operation that are to be incorporated into (e.g., superimposed over top of) the layout 700 at the location in the layout 700 corresponding to physical location of such equipment in the real world (e.g., the location of the equipment in the material handling facility 100). In some examples, these graphical components integrated into the layout can be updated dynamically (e.g., in real-time), thereby converting the static layout image of the material handing facility 100 into a dynamic view of the operations and/or status of equipment within the facility 100 in an intuitive manner that indicates the real-world physical relationship of the equipment within the facility. In some examples, these dynamic graphical components produced by the equipment graphic generating circuitry 614 and/or the GUI generating circuitry 616 have a size that is defined independent of the size of the layout 700. For example, a relatively high-resolution image of a facility map may include docks that have a width of 200 pixels within the image, whereas a lower resolution image of the same facility may represent the same docks with a width of only 50 pixels. Accordingly, in some examples, the layout manipulating circuitry 610 determines a scaling factor to increase and/or decrease the size of the layout 700 relative to the size of the graphical components generated by the equipment graphic generating circuitry 614 and/or the GUI generating circuitry 616 to ensure the graphical components match the size of the layout so that the resulting dynamic image can be easily understood by an end user viewing the graphics incorporated into the layout.

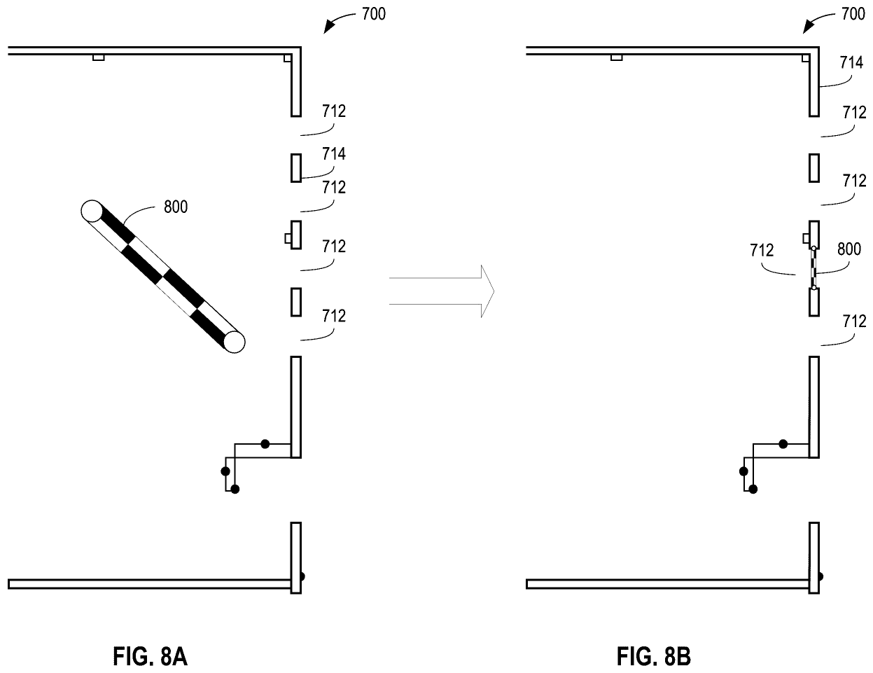

FIGS. 8A and 8B illustrate an example movable sizing graphic 800 used to scale the example layout 700 of FIG. 7. More particularly, FIG. 8A illustrates the movable sizing graphic 800 relative to the layout 700 prior to scaling. In this example, the movable sizing graphic 800 is intended to define the width of a dock doorway of a material handling facility. As can be seen in this example, the layout 700 is small, relative to the movable sizing graphic 800, inasmuch as dock sections 712 (e.g., dock doorways) are much smaller than the movable sizing graphic 800. FIG. 8B illustrates the movable sizing graphic 800 relative to the layout 700 after scaling. Specifically, in the illustrated example of FIG. 8B, the movable sizing graphic 800 has been moved, oriented, and/or resized (based on user input) to fit in (e.g., across) a dock section 712 of the layout. Once the sizing graphic 800 is in place, the layout manipulating circuitry 610 sets the scaling factor such that the dock section 712, as measured by sizing graphic 800, correlates to a standard (e.g., default) width of a doorway for a dock 102 of the material handling facility 100 of FIG. 1. Thus, future graphics generated by the equipment graphic generating circuitry 614 and the GUI generating circuitry 616 can be easily incorporated into the layout 700 with approximately the same scale. In some examples, the standard (e.g., default) width for a dock doorway is 10 feet. However, in other examples, the standard width can be greater or less than 10 feet. In some examples, there is no pre-set standard width. Rather, in some examples, the width of the dock sections 712 that are to correspond to the length of the sizing graphic 800 is specified by a user. In some such examples, a user is not limited to adjusting the sizing graphic 800 to the size of a dock section 712 within the layout but can adjust the sizing graphic 800 to any feature shown in the layout and then enter a known (e.g., measured) dimension for that feature to specify the scale of the layout. Thus, for example, if a user knows that a particular wall in the layout is 100 feet long, the user can adjust the sizing graphic 800 to the length of the wall and then specify that this length corresponds to 100 feet. Based on this input, the example layout manipulating circuitry 610 can determine the scale and/or dimensions of the layout 700 and all features in the layout 700. In some examples, the scaling of the layout 700 to the sizing graphic 800 is only “approximate” because it is based on user-input and, therefore, limited to the precision of the end user adjusting the sizing graphic 800. In some examples, the layout manipulating circuitry 610 is instantiated by programmable circuitry executing layout manipulating instructions and/or configured to perform operations such as those represented by the flowcharts of FIGS. 12, 14, and 15.

In some examples, the main server 128 includes means for manipulating a layout. For example, the means for manipulating may be implemented by layout manipulating circuitry 610. In some examples, the layout manipulating circuitry 610 may be instantiated by programmable circuitry such as the example programmable circuitry 1712 of FIG. 17. For instance, the layout manipulating circuitry 610 may be instantiated by the example microprocessor 1800 of FIG. 18 executing machine executable instructions such as those implemented by at least blocks 1206, 1208, 1210, 1216, 1408, 1506, 1508 of FIGS. 12-15. In some examples, layout manipulating circuitry 610 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the layout manipulating circuitry 610 may be instantiated by any other combination of hardware, software, and/or firmware. For example, the layout manipulating circuitry 610 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example equipment cataloguing circuitry 612 of FIG. 6 collects and organizes data about the docks 102, industrial doors 124, and/or other equipment of the example material handling facility 100 of FIG. 1 to be stored in the memory 618. In some examples, the equipment cataloguing circuitry 612 generates an asset list (e.g., equipment list, asset group) representative of the docks 102 and/or industrial doors 124 present in the material handling facility 100. The docks 102 and/or industrial doors 124 are identified (e.g., detected, discovered, etc.) by the equipment cataloguing circuitry 612 and designated as items in the asset list. In some examples, the docks 102 and/or industrial doors 124 are identified by device identification information sent by the controllers 116, 126. The asset list includes at least the device identification information (e.g., a unique identifier for the particular controller 116, 126 associated with each dock 102 and/or industrial door 124) and a list of the equipment (e.g., a door 104, a doorway barrier 106, a dock leveler 108, a vehicle restraint 110, a presence detector 112, and/or a notification system 114, etc.) associated with the asset (e.g., dock 102 or industrial door 124) or connected to the controller (e.g., dock controller 116, door controller 126). In some examples, the asset list includes all assets within a facility that includes multiple docks 102 and/or multiple industrial doors 124. In some such examples, items within the asset list associated with a given dock 102 and/or industrial door 124 are grouped together. Additionally or alternatively, the equipment cataloguing circuitry 612 generates separate asset lists for each dock 102 and each industrial door 124, with the equipment associated with each dock 102 and/or door 124 included in the corresponding asset list.

In some examples, the equipment cataloguing circuitry 612 identifies specific pieces of equipment associated with the controllers 116, 126 and adds data to the asset list representative of such equipment automatically based on data received from the controllers 116, 126. For instance, in some examples, the controllers 116, 126 include a user interface (e.g., the display screen 118 shown in FIG. 1) that enables a user to locally configure and/or identify all equipment connected to the corresponding controller 116, 126 so that the controller 116, 126 can then provide that information to the equipment cataloguing circuitry 612 of the main server 128. In other examples, the controllers 116, 126 do not have the capability to perform such local configurations. Instead, in some such examples, as the controller 116, 126 receives a signal from a connected piece of equipment indicating a state change of the piece of equipment the controller 116, 126 reports the signal to the main server 128 along with an address (e.g., an Internet Protocol (IP) address, a network address, etc.) associated with the signal. In some examples, the equipment cataloguing circuitry 612 is able to determine the type of equipment associated with the reported address (e.g., an IP address, a network address, etc.), thereby determining that the controller 116, 126 is associated with at least one instance of the identified type of equipment.

As a specific example, as discussed above, a vehicle restraint 110 includes a restraint sensor that may output a signal when vehicle restraint 110 switches between a locked position (e.g., in position to engage/restrain the vehicle) and an unlocked position (e.g., a position in which the vehicle restraint 110 is not intended to engage/restrain the vehicle). The associated dock controller 116 receives this signal and transmits it to the main server 128 along with an associated address for the restraint sensor and/or the associated signal, such as the address of “RestraintEngaged-003.” In this example, the equipment cataloguing circuitry 612 is able to recognize the address “RestraintEngaged-003” corresponds to a vehicle restraint 110, thereby determining that the controller 116 is operatively coupled to a vehicle restraint 110. Accordingly, the equipment cataloguing circuitry 612 adds a vehicle restraint 110 to the list of assets associated with the corresponding controller 116. In some examples, the equipment cataloguing circuitry 612 only adds the vehicle restraint 110 to the asset list if a threshold number of state changes are reported in connection with the associated address within a threshold period of time. Satisfying these thresholds provides redundancy to avoid false positives and incorrect identification of equipment items to be added to the asset list. To this end, the signal may be sent repeatedly. As additional items of equipment associated with the controller 116 undergo a stage change (e.g., a button is pushed, a warning light turns on or off, a sensor is triggered by relevant activity or movement of equipment, etc.), the resulting signals provided to the controller 116 are reported to the main server 128 along with addresses corresponding to the associated equipment, thereby enabling the equipment cataloguing circuitry 612 to generate a full list of assets associated with the controller 116. In some examples, once a particular item of equipment is identified as being associated with a given controller 116, 126, the equipment cataloguing circuitry 612 accesses and/or retrieves additional information about the equipment (e.g., model number, serial number, etc.) from a configuration file stored in the controller 116, 126. In some examples, there may not be a configuration file and/or no information may be available for some or all of the equipment identified and added to the asset list.

In addition to or instead of automatically detecting and adding equipment to an asset list, in some examples, the equipment cataloguing circuitry 612 adds data to the asset list based on user input. In some examples, user input to the asset list can include a descriptive name for the asset (e.g., Dock 6, West Receiving Dock, Freezer Door 1, etc.) and/or the presences of equipment not communicatively connected to or monitored by the controllers 116, 126 (e.g., a dock shelter, a trailer stand, etc.).

As noted above, the example equipment cataloguing circuitry 612 associates or groups pieces of equipment with a corresponding controller 116, 126. More particularly, in some examples, this association is based on the unique device identification information (e.g., serial number) of the corresponding controller 116, 126. As such, unless a user specifically knows the unique device identification information associated with each controller 116, 126, the user may not know which grouping of assets associated with multiple different controllers in the full asset list correspond to which particular controllers 116, 126 within a material handling facility. Accordingly, in some examples, the equipment cataloguing circuitry 612 facilitates the association of specific controllers 116, 126 with corresponding docks 102 and/or industrial doors 124 using an easily recognizable or intuitive name or label. That is, while a user may not know or easily remember the unique device identification information for a given controller 116, 126, the user may have descriptive names or labels for the associated docks 102 or doors 124 (e.g., Dock 01, Dock 02, Door A, Door B, Freezer Door 2, etc.) and the example equipment cataloguing circuitry 612 facilitates assigning these names to the correct controllers 116, 126 in the asset list for easy subsequent identification.

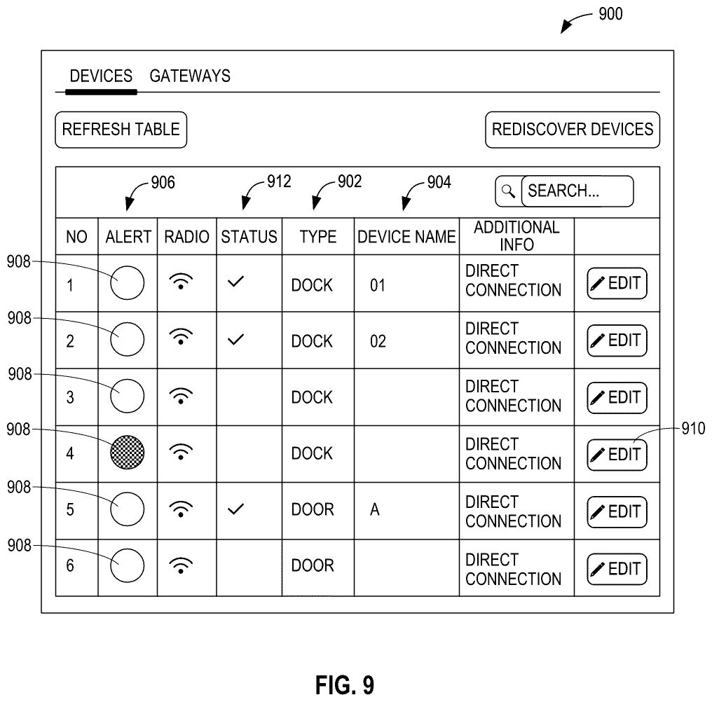

Specifically, FIG. 9 illustrates an example graphical user interface 900 that may be generated by the GUI generating circuitry 616 and used by the example equipment cataloguing circuitry 612 to obtain user input that provides a descriptive name to be assigned to each controller 116, 126 the equipment cataloguing circuitry 612 identified and added to the asset list. In the illustrated example, six different controllers 116, 126 identified by the equipment cataloguing circuitry 612 are listed. As noted above, in some examples, the equipment cataloguing circuitry 612 is able to determine the type of controller based on the device identification information provided by each controller 116, 126. In the illustrated example of FIG. 9, the device type is listed in the device type column 902. As shown, in this example, four dock controllers 116 have been identified and two door controllers 126 have been identified. Further, in this example, two of the dock controllers 116 have already been assigned a specific device name (e.g., “01” and “02”) and one of the two door controllers has already been assigned a specific device name (e.g., “A”) as indicated in the device name column 904.

In the illustrated example of FIG. 9, there are two dock controllers 116 identified by the equipment cataloguing circuitry 612 yet to be assigned a name. In some instances, a user may not know which row on the list corresponds to which associated dock 102 in the material handling facility 100. In some examples, to resolve this issue, the graphical user interface 900 includes an alert column 906 with indicators 908 that visually change in response to an alert signal (e.g., an equipment identifying signal) generated by the corresponding controller 116, 126. That is, in some examples, a given controller 116, 126 is provided with an input that a user can select (e.g., a button that a user can press or a particular sequence of button presses) to generate an alert signal that is transmitted to the main server 128 to identify the given controller 116, 126 as corresponding to a particular row in the list of assets shown in the graphical user interface 900. In response to receiving this signal, the example equipment cataloguing circuitry 612 causes (e.g., via the GUI generating circuitry 616) the associated indicator 908 to visually change appearance (e.g., change color, light up, become highlighted, change size, begin flashing, etc.). For instance, the indicator 908 on the fourth row of the example list appears different than the other indicators 908 (e.g., has a distinctive appearance) because an alert signal was just generated based on a user pressing the corresponding button(s) on the associated dock controller 116. In this manner, the user can confirm that the dock associated with the fourth row corresponds to the dock 102 at which the controller 116 is located that the user just caused to generate the alert signal. Accordingly, the user can select (e.g., click with a mouse or other point and select device) the associated edit button 910 and input the device name for the associated dock 102. Thereafter, the entered name will be populated in the device name column 904. Further, in this example, a checkmark will appear in the status column 912 to indicate the associated controller 116 has been properly named.

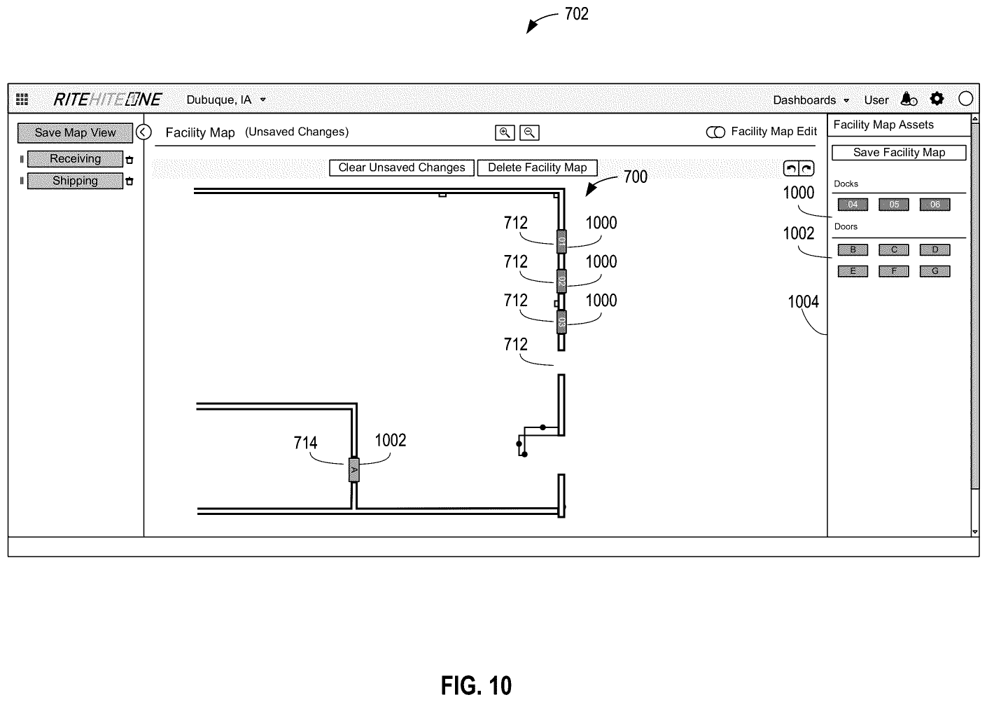

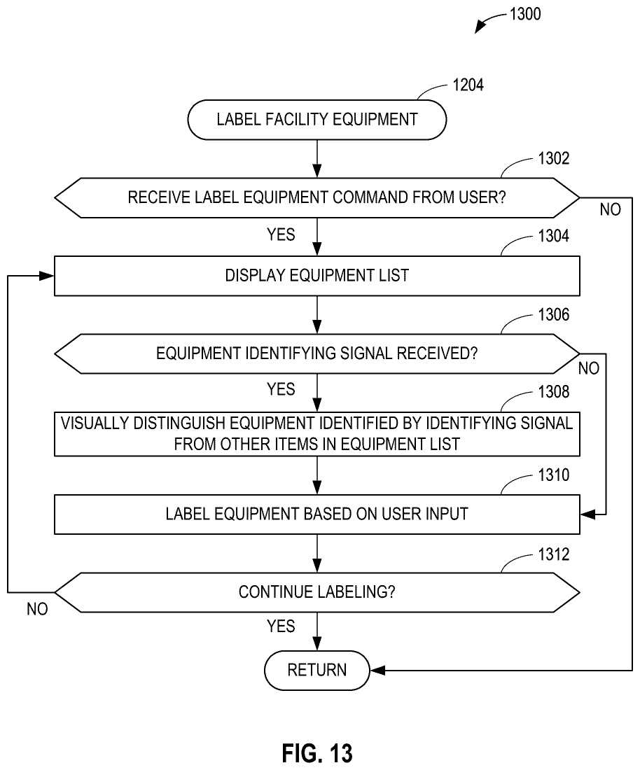

In some examples, the example equipment cataloguing circuitry 612 also associates a relative location and orientation within the layout with the docks 102 and doors 124 within the asset list. In some examples, the GUI generating circuitry 616 creates equipment markers (e.g., asset markers, graphics, icons, proxies, etc.) that can be positioned and oriented (e.g., rotated) on the layout 700 by the user. In some examples, each equipment marker is associated with particular equipment (e.g., a particular dock 102 or industrial door 124) in the material handling facility 100. The equipment marker position in the layout 700 is read by the equipment cataloguing circuitry 612 and stored in the memory 618, to be used by the GUI generating circuitry 616 to place equipment graphics generated by the equipment graphic generating circuitry 614, as described in further detail below. In other examples, the position and orientation of an equipment marker are received by the equipment cataloguing circuitry 612 through direct user input (e.g., coordinates, target pixel, etc.). FIG. 10 illustrates the placement of example equipment markers, dock markers 1000 and industrial door markers 1002, on the example layout 700. An example asset list 1004 displays equipment markers (dock markers 1000 and/or industrial door markers 1002) for assets generated by the equipment cataloguing circuitry 612. Each equipment marker includes a label (e.g., a string of number(s) and/or letter(s)) that is specified by a user (as discussed above in connection with FIG. 9 and further discussed below in connection with FIG. 13) to enable the user to associate each marker with a corresponding dock or industrial door of the material handling facility at the corresponding location represented in the layout 700. In this way, a user can select a dock marker 1000 or industrial door marker 1002 and place the marker on the corresponding location in the layout 700 based on the label of the marker. A portion of the equipment markers (dock markers 1000 and/or industrial door markers 1002) have been moved and rotated based on user input to align with the example dock sections 712 and industrial door section 714. Assets that have not been positioned remain in the asset list 1004 until moved by the user.

In some examples, the equipment cataloguing circuitry 612 is instantiated by programmable circuitry executing equipment cataloguing instructions and/or configured to perform operations such as those represented by the flowcharts of FIGS. 12, 13, and 15.

In some examples, the main server 128 includes means for cataloguing equipment. For example, the means for cataloguing may be implemented by equipment cataloguing circuitry 612. In some examples, the equipment cataloguing circuitry 612 may be instantiated by programmable circuitry such as the example programmable circuitry 1712 of FIG. 17. For instance, the equipment cataloguing circuitry 612 may be instantiated by the example microprocessor 1800 of FIG. 18 executing machine executable instructions such as those implemented by at least blocks 1202, 1204, 1210, 1304, 1310, and 1508 of FIGS. 12, 13, and 15. In some examples, equipment cataloguing circuitry 612 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the equipment cataloguing circuitry 612 may be instantiated by any other combination of hardware, software, and/or firmware. For example, the equipment cataloguing circuitry 612 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example equipment graphic generating circuitry 614 of FIG. 6 generates graphics that represent the docks 102 and/or industrial doors 124 of the example material handling facility 100 of FIG. 1. The graphics (e.g., icons, images, symbols, etc.) generated by the equipment graphic generating circuitry 614 reflect asset data (e.g., types of sensors and/or equipment associated with the asset, the name or label for the asset, etc.) stored by the equipment cataloguing circuitry 612 as well as IO data collected from the equipment and processed by the IO data analyzing circuitry 608. In this way, a graphic is generated for each asset in the asset list that corresponds to what kind of equipment is present and related statuses of the equipment. Such graphics can be displayed in conjunction with the layout 700 at the corresponding locations at which each dock marker 1000 and/or industrial door marker 1002 (associated with each asset) was placed, as discussed above in connection with FIG. 10.

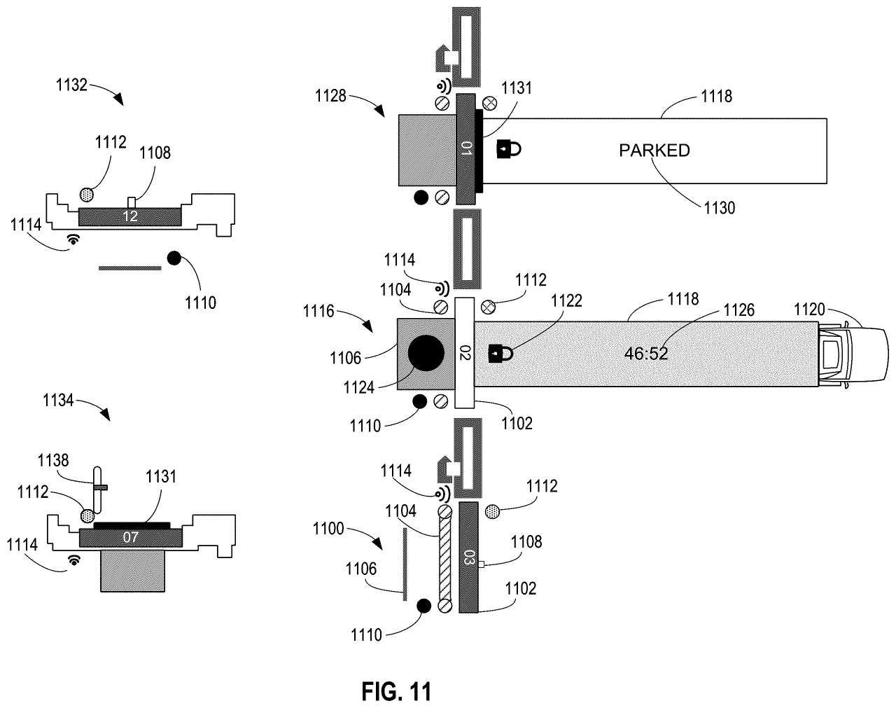

FIG. 11 illustrates example equipment graphics generated by the example equipment graphic generating circuitry 614. An example first dock graphic 1100 includes a dock door symbol 1102, a doorway barrier symbol 1104, a dock leveler symbol 1106, a first vehicle restraint symbol 1108, a presence detector symbol 1110, an exterior notification system symbol 1112, and a communication status symbol 1114. An example second dock graphic 1116 includes a similar dock door symbol 1102, a doorway barrier symbol 1104, a dock leveler symbol 1106, a presence detector symbol 1110, an exterior notification system symbol 1112, and a communication status symbol 1114 as in the first dock graphic 1100. However, the symbols 1102, 1104, 1106, 1108, 1110, 1112, 1114 included in the second dock graphic 1116 have been modified relative to the corresponding symbols in the first dock graphic 1100 due to differences in the status of the equipment associated with the two docks represented by the two dock graphics 1100, 1116. Specifically, in the illustrated examples, the first dock graphic 1100 represents a dock that is closed (e.g., secured, locked, etc.) and inactive (e.g., unused), whereas the second dock graphic 1116 represents a dock that is in use with a trailer at the dock as represented by a trailer symbol 1118 and a tractor symbol 1120.

In the illustrated example, the dock door symbol 1102 in the first dock graphic 1100 is represented by a rectangle placed in a dock location (e.g., the dock section 712 of FIG. 7). In some examples, the dock door symbol 1102 has a same size and shape as the dock markers 1000 of FIG. 10 that are used by a user to initially define the position for the dock graphics in the layout 700. In some examples, the dock door symbol 1102 changes appearance to indicate whether the associated dock door 104 is opened or closed. For instance, in the illustrated example, the dock door symbol 1102 of the first dock graphic 1100 is shaded to indicate that the corresponding door 104 at the corresponding real-world dock 102 is in a closed position. By contrast, the dock door symbol 1102 of the second dock graphic 1116 is not shaded. Rather, the dock door symbol 1102 of the second dock graphic 1116 is illustrated as unshaded to indicate that the corresponding door 104 at the corresponding real-world dock 102 is in an open position. In other examples, the dock door symbol 1102 can have any other suitable appearance and/or change in any other suitable manner between the closed and open positions.

The doorway barrier symbol 1104 of the first dock graphic 1100 is represented as extending across a doorway associated with the dock to indicate the corresponding doorway barrier 106 at the corresponding real-world dock 102 is deployed (or lowered if the doorway barrier is implemented with a vertically translating gate). By contrast, the doorway barrier symbol 1104 of the second dock graphic 1116 does not extend across the doorway to indicate the doorway barrier 106 is retracted (or raised in the case of a vertically translating gate). However, the doorway barrier symbol 1104 in the second dock graphic 1116 includes two circles representing the two posts between which the doorway barrier 106 extends. In other examples, the doorway barrier symbol 1104 can have any other suitable appearance and/or change in any other suitable manner between the deployed and retracted positions.

The dock leveler symbol 1106 in the first dock graphic 1100 is indicated by a narrow line spaced apart from the dock door symbol 1102 to represent the corresponding dock leveler 108 is stowed. By contrast, the dock leveler symbol 1106 in the second dock graphic 1116 extends up to the dock door symbol 1102 to represent that the dock leveler 108 is deployed. In other examples, the dock leveler symbol 1106 can have any other suitable appearance and/or change in any other suitable manner between the deployed and stowed positions. For instance, in some examples, the narrow line for the dock leveler symbol 1106 in the first dock graphic 1100 may be limited to representing the stowed position of vertically stowed levelers, while a different appearance is used to represent levelers that are not vertically stowed. In other examples, the same appearance can be used for all types of levelers in the stowed position.

The first vehicle restraint symbol 1108 in the first dock graphic 1100 indicates the presence of a vehicle restraint 110 at the corresponding dock 102. However, in this example, the vehicle restraint 110 is inactive because there is no trailer at the corresponding dock with which the restraint may engage. Inasmuch as the dock graphics 1100, 1116 are intended to intuitively convey information about docks from a birds-eye or overhead view, when a trailer is present at a dock, the vehicle restraint 110 would not be visible because it would be underneath the trailer. For this reason, the first vehicle restraint symbol 1108 is omitted in the second dock graphic 1116. However, in some examples, the second dock graphic 1116 includes a second vehicle restraint symbol 1122 to indicate that the vehicle restraint 110 in the real-world is physically engaged with (e.g., restraining) the corresponding trailer. In this example, the second vehicle restraint symbol 1122 is a lock. However, any other symbol could be used.

The presence detector symbol 1110 indicates that a presence detector 112 is located at a corresponding dock 102. The first dock graphic 1100 shows a presence detector symbol 1110 on an interior side of the dock. The second dock graphic 1116 also shows a presence detector symbol 1110 as well as an activity symbol 1124 to indicate that the presence detector 112 is detecting activity (e.g., movement) within the trailer. In some examples, when movement is detected in a trailer by the presence detector 112 a light is projected onto the ground within the material handling facility 100 in front of the trailer opening to provide notice to anyone nearby the dock that there is movement within the trailer. Accordingly, in this example, the activity symbol 1124 is a circle positioned at a similar location as the projected light signal to match the real-world indication provided by the presence detector 112. In some examples, the activity symbol 1124 has the same color as the real-world light projected onto the ground in front of the trailer opening. In other examples, any other symbols can be used for the activity symbol 1124. Notably, in this example, the appearance or non-appearance of the activity symbol 1124 within the dock graphic 1116 indicated whether or not movement is detected within the trailer. By contrast, as noted above, the presence detector symbol 1110 serves to indicate whether or not a presence detector is positioned at the corresponding dock. The presence detector symbol 1110 serves to inform an end user whether the absence of the activity symbol 1124 is because there is no movement detected in the trailer or whether movement in the trailer is simply not being monitored (e.g., because there is no presence detector at that location).

The external notification symbol 1112 indicates the status of the light indicators 206 (shown in FIG. 2) at the corresponding dock 102. In the first dock graphic 1100, the example external notification symbol 1112 is represented by a colored circle. In some examples, the color of the external notification symbol 1112 mirrors or otherwise coincides with the signals of the light indicators 206 at the corresponding dock 102. In the example first dock graphic 1100, the external notification symbol 1112 is colored (e.g., green in appearance) to notify others (e.g., drivers, workers, others outside of the material handling facility, etc.) that the dock is available to receive a trailer and/or that the vehicle restraint 110 has been disengaged so that a trailer is available to leave the dock. In contrast, the external notification symbol 1112 in the second dock graphic 1116 is colored (e.g., red in appearance) to notify others that the dock is occupied, the trailer 300 is secured, or to otherwise indicate that caution should be taken around the dock.

The communication status symbol 1114 of the first dock graphic 1100 indicates that communication between a corresponding IO communication board 134 of the dock 102 and the network communications interface circuitry 602 is active. While the communication status symbol 1114 resembles symbols for wireless communication, the actual network connection can be made with any form of network communication (e.g., Wi-Fi, ethernet, cellular, etc.). In some examples, the communication status symbol 1114 disappears or is otherwise altered (e.g., changes color, begins flashing, etc.) to indicate a lack of communication with the network or equipment that lacks communication equipment such as the IO communication board 134 of the dock 102. In other examples, another icon or symbol is used to indicate active communications between the corresponding dock 102 and the main server 128.

The trailer symbol 1118 of the second dock graphic 1116 includes a timer symbol 1126 to represent an amount of time (e.g., a duration) that a trailer is being worked on (e.g., loaded or unloaded). In some examples, the timer symbol 1126 corresponds with the timing indicator 306 of the notification system 114 and/or display screen 118 of the corresponding real-world dock 102. The example third dock graphic 1128 includes a trailer symbol 1118 without a corresponding tractor symbol (e.g., tractor symbol 1120). In contrast, the trailer symbol 1118 of the third dock graphic 1128 includes a status text 1130. The status text 1130 of the third dock graphic 1128 indicates that the real-world trailer 300 at the corresponding dock 102 is parked. In other examples, the status text 1130 can be used to provide any status of the trailer and/or dock (e.g., trailer for storage, a dock under repair, the presence of a waste or scrap receptacle, etc.). In this example, the third dock graphic 1128 includes a shelter symbol 1131 to indicate the corresponding dock 102 at this location includes a shelter and/or associates seals to surround the opening of the trailer 300 parked at the dock 102. By contrast, the first and second dock graphics 1100, 1116 do not include the shelter symbol 1131 to indicate the corresponding docks do not include such a shelter. In some examples, whether or not a dock graphic includes a shelter symbol 1131 is determined based on a user specifying whether the corresponding real-world dock includes a shelter.

The example fourth and fifth dock graphics 1132, 1134 show docks with fewer and/or different pieces of equipment than the first, second, and third dock graphics 1100, 1116, 1128. The equipment graphic generating circuitry 614 generates the graphics based on equipment automatically detected (by the example equipment cataloguing circuitry 612 as discussed above) and/or manually entered into the asset list. Thus, the different features or symbols shown in the door graphics can be combined in any manner to reflect the arrangement of equipment at any given dock and dynamically updated to reflect the status or conditions of the equipment at the given dock. For example, the fourth and fifth dock graphics 1132, 1134 lack a doorway barrier. The fourth dock graphic 1132 includes a presence detector symbol 1110, whereas the fifth dock graphic 1134 does not. The fifth dock graphic 1134 illustrates a shelter symbol 1131, whereas the fourth dock graphic 1132 does not. In other examples, different symbols can be used to denote a different style of equipment that performs similar tasks. For example, the example vehicle restraint symbol 1108 of the fourth dock graphic 1132 (and shown in the first dock graphic 1100) is indicative of a vehicle restraint that engages with a rear impact guard of a trailer. Alternatively, an example vehicle restraint symbol 1138 of the fifth dock graphic 1134 is indicative of a vehicle restraint that engages a tire of a trailer.

The equipment graphic generating circuitry 614 of the main server 128 generates a variety of equipment graphics to reflect the docks 102 and the statuses thereof. The example equipment graphics of FIG. 11 show graphics and statuses for docks. In other examples, the equipment graphic generating circuitry 614 can generate graphics for other assets such as industrial doors 124 of the material handling facility 100.

In some examples, the equipment graphic generating circuitry 614 is instantiated by programmable circuitry executing equipment graphic generating instructions and/or configured to perform operations such as those represented by the flowcharts of FIGS. 12 and 16.

In some examples, the main server 128 includes means for generating equipment graphics. For example, the means for generating may be implemented by equipment graphic generating circuitry 614. In some examples, the equipment graphic generating circuitry 614 may be instantiated by programmable circuitry such as the example programmable circuitry 1712 of FIG. 17. For instance, the equipment graphic generating circuitry 614 may be instantiated by the example microprocessor 1800 of FIG. 18 executing machine executable instructions such as those implemented by at least blocks 1214, 1216, and 1610 of FIGS. 12 and 16. In some examples, equipment graphic generating circuitry 614 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the equipment graphic generating circuitry 614 may be instantiated by any other combination of hardware, software, and/or firmware. For example, the equipment graphic generating circuitry 614 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example GUI generating circuitry 616 of the main server 128 of FIG. 6 generates GUIs (e.g., the GUIs shown in FIGS. 7, 9, and 10) for display on web pages hosted by the web server 136. In some examples, the GUI generating circuitry 616 generates GUIs for other apps, applets, applications, etc., accessible by the client device 138 independent of the web server 136. The GUIs generated by the example GUI generating circuitry 616 may be based on outputs of the IO data analyzing circuitry 608, the layout manipulating circuitry 610, the equipment cataloguing circuitry 612, and/or equipment graphic generating circuitry 614. In some examples, the GUIs generated by the GUI generating circuitry 616 generate icons, graphics, or other tools (e.g., the sizing graphic 800 of FIGS. 8A and 8B, the list of detected devices shown in FIG. 9, the dock markers 1000 of FIG. 10, etc.) to receive or otherwise capture user inputs. In some examples, the GUI generating circuitry 616 is instantiated by programmable circuitry executing GUI generating instructions and/or configured to perform operations such as those represented by the flowchart of FIGS. 12-16.

In some examples, the main server 128 includes means for generating a graphical user interface and/or means for providing information to a user. For example, the means for generating and/or means for providing may be implemented by GUI generating circuitry 616. In some examples, the GUI generating circuitry 616 may be instantiated by programmable circuitry such as the example programmable circuitry 1712 of FIG. 17. For instance, the GUI generating circuitry 616 may be instantiated by the example microprocessor 1800 of FIG. 18 executing machine executable instructions such as those implemented by at least blocks 1208, 1210, 1216, 1302, 1304, 1308, 1310, 1402, 1404, 1406, 1502, 1506, and 1508 of FIGS. 12-15. In some examples, the GUI generating circuitry 616 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the GUI generating circuitry 616 may be instantiated by any other combination of hardware, software, and/or firmware. For example, the GUI generating circuitry 616 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the main server 128 of FIG. 1 is illustrated in FIG. 6, one or more of the elements, processes, and/or devices illustrated in FIG. 6 may be combined, divided, re-arranged, omitted, eliminated, and/or implemented in any other way. Further, the example web server 136, the example network communications interface circuitry 602, the example IO network interface circuitry 604, the example data logging circuitry 606, the example IO data analyzing circuitry 608, the example layout manipulating circuitry 610, the example equipment cataloguing circuitry 612, the example equipment graphic generating circuitry 614, the example GUI generating circuitry 616, the example memory 618, and/or, more generally, the example main server 128 of FIG. 6, may be implemented by hardware alone or by hardware in combination with software and/or firmware. Thus, for example, any of the example web server 136, the example network communications interface circuitry 602, the example IO network interface circuitry 604, the example data logging circuitry 606, the example IO data analyzing circuitry 608, the example layout manipulating circuitry 610, the example equipment cataloguing circuitry 612, the example equipment graphic generating circuitry 614, the example GUI generating circuitry 616, the example memory 618, and/or, more generally, the example main server 128, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs. Further still, the example main server 128 of FIG. 6 may include one or more elements, processes, and/or devices in addition to, or instead of, those illustrated in FIG. 6, and/or may include more than one of any or all of the illustrated elements, processes and devices.

Flowcharts representative of example machine readable instructions, which may be executed by programmable circuitry to implement and/or instantiate the main server 128 of FIG. 6 and/or representative of example operations which may be performed by programmable circuitry to implement and/or instantiate the main server 128 of FIG. 6, are shown in FIGS. 12, 12, 14, 15, and/or 16. The machine readable instructions may be one or more executable programs or portion(s) of one or more executable programs for execution by programmable circuitry such as the programmable circuitry 1712 shown in the example processor platform 1700 discussed below in connection with FIG. 17 and/or may be one or more function(s) or portion(s) of functions to be performed by the example programmable circuitry (e.g., an FPGA) discussed below in connection with FIGS. 18 and/or 19. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 12, 13, 14, 15, and/or 16, many other methods of implementing the example main server 128 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, multiple processors distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 12, 13, 14, 15, and/or 16 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 12 is a flowchart representative of example machine readable instructions and/or example operations 1200 that may be executed, instantiated, and/or performed by programmable circuitry to identify equipment in a material handling facility and to display status information relating to the equipment on a layout of the material handling facility. The example machine-readable instructions and/or the example operations 1200 of FIG. 12 begin at block 1202, at which the example equipment cataloguing circuitry 612 generates a facility equipment list (e.g., asset list). For purposes of explanation, the equipment referred to in the flowcharts can refer to the dock 102, the industrial door 124, and/or a collection of components of the industrial door 124 that are located within the material handling facility. In some examples, other types of equipment may also be identified and included in the facility equipment list. The equipment cataloguing circuitry 612 receives data from the example IO network interface circuitry 604 and/or the IO data analyzing circuitry 608 to identify equipment and related sensors that are associated with a controller in the facility (e.g., the example dock controller 116 or the example door controller 126). The identified equipment is stored in a list by the data logging circuitry 606 in the example memory 618. In some examples, the different items or assets of equipment are identified in the equipment list by an arbitrary identifier and/or an identifier (e.g., serial number) included in the data collected from the equipment. In some examples, the identifier used in the equipment list may not be recognizable by an end user. In other examples, no identifier is assigned for a newly identified equipment asset and a blank placeholder for a label is included in the list. As a result, an end user would not be able to easily recognize the listed equipment to associate it to the corresponding equipment in the material handling facility 100. Accordingly, at block 1204, the equipment cataloguing circuitry 612 labels (e.g., relabels) the facility equipment identified at block 1202 by the user to match the controllers 116, 126 and/or other items in the equipment list with user-recognizable names for the corresponding dock 102 and/or industrial door 124. In some examples, the user-recognizable names or labels are obtained from and/or provided by a user as discussed above in connection with FIG. 9. Further detail regarding the implementation of block 1204 is provided below in connection with FIG. 13.

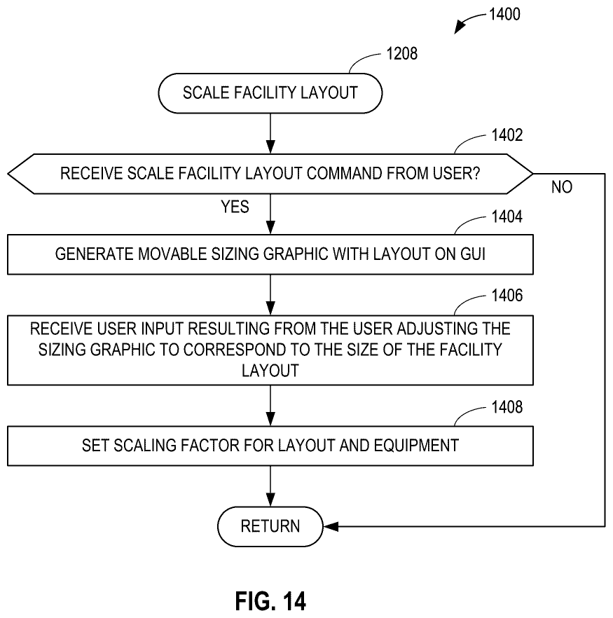

At block 1206, the example layout manipulating circuitry 610 generates a layout representative of the facility. In some examples, the layout is based on an image or other datafile received through the example network communications interface circuitry 602. In some such examples, the layout manipulating circuitry 610 generates the layout by converting the datafile into a more suitable format. In some examples, the layout manipulating circuitry 610 may implement other pre-processing of the user-provided input to generate the layout. In some examples, the datafile as received is already in a suitable format and no processing is required to generate the layout for use in accordance with examples disclosed herein. In some examples, the layout manipulating circuitry 610 generates the layout based on user input through the example GUI generating circuitry 616. That is, in some examples, a user can construct or build the layout directly within an example GUI using the layout manipulating circuitry 610 and/or the example GUI generating circuitry 616. At block 1208, the layout manipulating circuitry 610 and/or the GUI generating circuitry 616 scales the layout in response to user input. Further detail regarding the implementation of block 1208 is provided below in relation to FIG. 14.

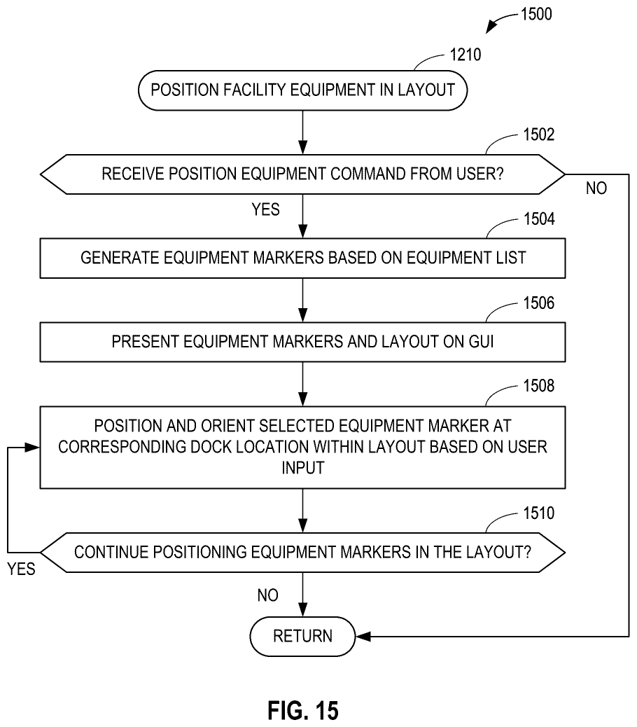

At block 1210, the GUI generating circuitry 616 positions facility equipment in the facility layout based on user input. In some examples, the layout manipulating circuitry 610, the equipment cataloguing circuitry 612, and the GUI generating circuitry 616 work together to store positions of the facility equipment relative to the facility layout for later use by the main server 128. Further detail regarding the implementation of block 1210 is provided below in relation to FIG. 15.

At block 1212, the IO data analyzing circuitry 608 monitors IO data (e.g., sensor feedback data, equipment status data, etc.) provided by the IO network interface circuitry 604 to generate and/or determine a status of and/or condition associated with the facility assets within the equipment list. In some examples, monitoring the IO data includes the data logging circuitry 606 storing the IO data in memory (e.g., the memory 618) for later use.

At block 1214, the equipment graphic generating circuitry 614 generates equipment graphics to depict the status and/or associated conditions of the facility equipment corresponding to the IO data analyzing circuitry 608. Further detail regarding implementation of block 1214 is provided below in connection with FIG. 16. As discussed below, the equipment graphic generating circuitry 614 generates graphics that depict the equipment that make up a dock or industrial door as well as a status and/or associated conditions of the equipment.

At block 1216, the GUI generating circuitry 616 generates or displays the equipment graphics (generated by the equipment graphic generating circuitry 614 at block 1214) and the facility layout (generated by the layout manipulating circuitry 610 at block 1206) within an associated GUI. The equipment graphics are displayed with the layout, as scaled by the layout manipulating circuitry 610 (at block 1208), at a position and orientation relative to the layout as recorded by the equipment cataloguing circuitry 612. In some examples, the graphics and/or layout can be displayed at different sizes (e.g., enlarged, zoomed in, zoomed out, etc.) or at different locations (e.g., focused on a single dock or group of docks) by the layout manipulating circuitry 610 based on user input. At block 1218, the main server 128 determines whether to continue monitoring the IO data. If so, control returns to block 1212. Otherwise, control moves to block 1220 where the main server 128 determines if the equipment list and/or the facility layout should be updated. In some examples, the main server 128 determines whether the equipment list and/or the facility layout should be updated based on a user input and/or based on the detection of new equipment communicating with the main server 128. If so, control returns to block 1202. Otherwise, the example process of FIG. 12 ends.

FIG. 13 is a flowchart representative of example machine readable instructions and/or example operations 1300 that may be executed, instantiated, and/or performed by programmable circuitry to implement block 1204 of FIG. 12. The machine readable instructions and/or the operations 1300 of FIG. 13 begin at block 1302, where the main server 128 determines if a label equipment command has been received from the user. As used in this context, a label equipment command is a command from a user to initiate a process that enables the user to provide user-recognizable labels or names to different items of equipment in the equipment list generated at block 1202 of FIG. 12. In some examples, the GUI generating circuitry 616 receives the command from the user through an example GUI provided to a website and/or user device. If no command to label equipment has been received, the operation 1300 of FIG. 13 returns to block 1206 of FIG. 12. Otherwise, the operations 1300 continue to block 1304 where the GUI generating circuitry 616 displays an equipment list generated by the equipment cataloguing circuitry 612. The equipment list shows all equipment detected by the equipment cataloguing circuitry 612 or otherwise received by user input. As discussed above, FIG. 9 is an example graphical user interface that displays a list of assets to be named or labelled.

At block 1306, the IO data analyzing circuitry 608 determines whether a controller (e.g., dock controller 116, door controller 126) is sending an equipment identifying signal through the IO network interface circuitry 604. In some examples, the equipment identifying signal is generated in response to a user input given directly to the controller (e.g., through user input to the display screen 118 of the dock controller 116 and/or by pressing any other designated button(s)). If an equipment identifying signal is detected at block 1306, the operations 1300 continue to block 1308. If not, the operations 1300 skip to block 1310. At block 1308, the GUI generating circuitry 616 visually differentiates the asset present in the equipment list that corresponds with the identifying signal received by the IO data analyzing circuitry 608. That is, as discussed above in connection with the illustrated example of FIG. 9, the indicator 908 associated with the corresponding controller 116, 126 changes appearance. In some examples, distinguishing the asset includes highlighting the entry in a contrasting color or adding an additional graphic or icon to denote an identified status. Once the asset is suitably distinguished, the operations 1300 continue to block 1310 where the asset of the equipment list is labeled (or relabeled) based on user input received by the GUI generating circuitry 616. In some examples, the label is stored by the equipment cataloguing circuitry 612 in the memory 618. Visually distinguishing a particular item in the equipment list based on an equipment identifying signal manually triggered by a person at the corresponding equipment (e.g., a particular dock 102 or industrial door 124) enables a user to easily identify which asset in the equipment list corresponds to the particular dock 102 or industrial door 124 of the material handling facility. Visually distinguishing the equipment is advantageous, particularly in large material handling facility with many docks 102 and/or industrial doors 124 that are otherwise difficult to distinguish. A user-recognizable (e.g., user defined) label is added to the equipment list to describe the asset, its location, and/or its function.

As suggested at block 1306, the equipment can, in some examples, be labeled based on user input without being visually distinguished. In this case, the user identifies the equipment based on some other data present in the equipment list (e.g., the device identification information, a unique identifier, the only item of equipment not already labeled, etc.). Continuing to block 1312, the main server 128 determines whether to continue the labeling process. In some examples, determining whether to continue the labeling process is based on receiving a user input to stop the labeling process. If the labeling process continues, the operations 1300 returns to block 1304. If the labeling process is not continued, the operations 1300 return to block 1206 of FIG. 12.

FIG. 14 is a flowchart representative of example machine readable instructions and/or example operations 1400 that may be executed, instantiated, and/or performed by programmable circuitry to implement block 1208 of FIG. 12. The machine readable instructions and/or the operations 1400 of FIG. 14 begin at block 1402, where the main server 128 determines if a scale facility layout command has been received from the user. As used in this context, a scale facility layout command is a command from a user to initiate a process that enables the user to provide input defining the scale of the facility layout generated at block 1206 of FIG. 12. In some examples, the GUI generating circuitry 616 receives the command from the user through an example GUI provided to a website and/or user device. If no command to scale the facility layout has been received, the operations 1400 of FIG. 14 returns to block 1210 of FIG. 12. Otherwise, the operations 1400 continue to block 1404 where the GUI generating circuitry 616 generates a movable sizing graphic for display with (e.g., superimposed on) the layout on the GUI (e.g., the sizing graphic 800 of FIG. 8).

At block 1406, the GUI generating circuitry 616 receives the user input resulting from the user adjusting the sizing graphic 800 to correspond to the size of the facility layout. In some examples, the user input from adjusting the sizing graphic 800 includes the user manipulating (e.g., moving) the sizing graphic 800 to a location of the layout corresponding to a dock, orienting the resizing graphic to the location corresponding to the dock, and changing a size of the resizing graphic to match with the portion of the layout corresponding with the width of the dock. At block 1408, the layout manipulating circuitry 610 sets a scaling factor for the layout and the equipment. The scaling factor defines the size or scale of the layout so that dock locations in the layout correspond to (e.g., match) a size of dock graphics, such that subsequent graphics generated (e.g., equipment graphics generated by equipment graphic generating circuitry 614, or graphics generating by the GUI generating circuitry 616) can be sized to match the layout. In this way, icons, graphics, and other visuals generated by the main server 128 have a matching size or scale to corresponding parts of the layout. Once the scaling factor is set at block 1408, the operations 1400 return to block 1210 of FIG. 12.

FIG. 15 is a flowchart representative of example machine readable instructions and/or example operations 1500 that may be executed, instantiated, and/or performed by programmable circuitry to implement block 1210 of FIG. 12. The machine readable instructions and/or the operations 1500 of FIG. 15 begin at block 1502, where the main server 128 determines if a position facility equipment in layout command has been received from the user. As used in this context, a position facility equipment in layout command is a command from a user to initiate a process that enables the user to provide input defining the location of equipment within the facility layout generated at block 1206 of FIG. 12. In some examples, the GUI generating circuitry 616 receives the command from the user through an example GUI provided to a website and/or user device. If no command to position equipment has been received, the operation 1500 of FIG. 15 returns to block 1212 of FIG. 12. Otherwise, the operations 1500 continue to block 1504 where the GUI generating circuitry 616 generates equipment markers (e.g., dock markers, door markers) based on the equipment list. The equipment markers represent assets on the equipment list and are sized to match corresponding locations on the layout. In some examples, the equipment markers share a label with the corresponding asset in the equipment list. At block 1506, the equipment markers and layout are presented by the GUI generating circuitry 616 and the layout manipulating circuitry 610 on the GUI.

At block 1508, the GUI generating circuitry 616 positions and/or orients, based on user input, an equipment marker of the equipment markers previously presented to a corresponding dock location or industrial door location on the layout. In some examples, the user moves (e.g., clicks and drags, rotates, aligns, etc.) the equipment marker on the GUI to a location on the layout corresponding to the label of the equipment marker. Once the equipment marker is positioned, the equipment cataloguing circuitry 612 stores the location and orientation of the marker. In some examples, all the equipment associated with the corresponding equipment asset and all the data being collected from that equipment is already associated with the equipment marker selected by the user. Thus, the user does not need to do any significant configuration of the layout after clicking and dragging the equipment marker to the proper position in the layout because this is done automatically based on the previous discovery of the equipment associated with the equipment. Continuing to block 1510, the main server 128 determines whether to continue the positioning process. In some examples, determining whether to continue the positioning process is based on receiving a user input to stop the positioning process. If the positioning process continues, the operations 1500 return to block 1508. If the labeling process is not continued, the operations 1500 return to block 1212 of FIG. 12.

FIG. 16 is a flowchart representative of example machine readable instructions and/or example operations 1600 that may be executed, instantiated, and/or performed by programmable circuitry to implement block 1214 of FIG. 12. The machine readable instructions and/or the operations 1600 of FIG. 16 begin at block 1602, where the main server 128 receives data associated with a status of equipment (e.g., assets of the equipment list). The status data corresponds to and/or is generated from IO data received by the IO network interface circuitry 604 and/or stored by the data logging circuitry 606. In some examples, the status data reflects an operational condition of the equipment. In some examples, the status data is received from user input (e.g., an input assigning a status to the equipment). At block 1604, the main server 128 determines if a change is detected in the received data and/or the stored data. In some examples, the detected change in status is new IO data received from equipment recently added or recently powered on. If no status data change was detected, the operations 1600 return to block 1216 of FIG. 12. If a change in status data was detected, the operations 1600 continue to block 1606. At block 1606, the IO data analyzing circuitry 608 identifies equipment (e.g., assets within the equipment list) associated with the detected change in data. At block 1608, the IO data analyzing circuitry 608 determines the equipment status based on the changed data. The determined equipment status can include whether or not a component of the equipment is active and/or deployed, conditions around or near the equipment (e.g., motion or activity near the dock and/or door), what signals and/or notifications are being displayed or transmitted by equipment, etc. In some examples, the determined equipment status includes the state of a timing indicator (e.g., the timing indicator 306). In other examples, IO data stored in the data logging circuitry 606 is used to determine a duration of the status (e.g., the length of time a trailer is parked at a dock).

At block 1610, the equipment graphic generating circuitry 614 generates an equipment graphics with symbols (e.g., the symbols 1102, 1104, 1106, 1108, 1110, 1112, 1114, 1118, 1120, 1122, 1124, 1126, 1131, 1138) corresponding to the status of the equipment with changed data. The example equipment graphics, as illustrated in FIG. 11, represent particular items of the equipment associated with the corresponding dock and/or industrial door as well as the status of the items of equipment. In some examples, generated equipment graphics persist until a change has been detected and the generated equipment graphics are updated to reflect the change. At block 1612, the equipment graphic generating circuitry 614 and the IO data analyzing circuitry 608 determine if any equipment remains that has changed IO data. If more equipment with changed IO data is detected, the operation 1600 moves to block 1606 to generate an equipment graphic for the next asset. If no more equipment with changed IO data is detected, the operation 1600 returns to block 1216 of FIG. 12.

FIG. 17 is a block diagram of an example programmable circuitry platform 1700 structured to execute and/or instantiate the example machine-readable instructions and/or the example operations of FIGS. 12, 13, 14, 15, and/or 16 to implement the main server 128 of FIG. 6. The programmable circuitry platform 1700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 1700 of the illustrated example includes programmable circuitry 1712. The programmable circuitry 1712 of the illustrated example is hardware. For example, the programmable circuitry 1712 can be implemented by one or more integrated circuits, logic circuits, FPGAs, microprocessors, CPUs, GPUs, VPUs, DSPs, and/or microcontrollers from any desired family or manufacturer. The programmable circuitry 1712 may be implemented by one or more semiconductor based (e.g., silicon based) devices. In this example, the programmable circuitry 1712 implements the web server 136, the network communications interface circuitry 602, the IO network interface circuitry 604, the data logging circuitry 606, the IO data analyzing circuitry 608, the layout manipulating circuitry 610, the equipment cataloguing circuitry 612, the equipment graphic generating circuitry 614, and the GUI generating circuitry 616.

The programmable circuitry 1712 of the illustrated example includes a local memory 1713 (e.g., a cache, registers, etc.). The programmable circuitry 1712 of the illustrated example is in communication with main memory 1714, 1716, which includes a volatile memory 1714 and a non-volatile memory 1716, by a bus 1718. The volatile memory 1714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1716 may be implemented by flash memory and/or any other desired type of memory device. Access to the main memory 1714, 1716 of the illustrated example is controlled by a memory controller 1717. In some examples, the memory controller 1717 may be implemented by one or more integrated circuits, logic circuits, microcontrollers from any desired family or manufacturer, or any other type of circuitry to manage the flow of data going to and from the main memory 1714, 1716.

The programmable circuitry platform 1700 of the illustrated example also includes interface circuitry 1720. The interface circuitry 1720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1722 are connected to the interface circuitry 1720. The input device(s) 1722 permit(s) a user (e.g., a human user, a machine user, etc.) to enter data and/or commands into the programmable circuitry 1712. The input device(s) 1722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1724 are also connected to the interface circuitry 1720 of the illustrated example. The output device(s) 1724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1720 of the illustrated example, thus, typically includes a graphics driver card, a graphics driver chip, and/or graphics processor circuitry such as a GPU.

The interface circuitry 1720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1700 of the illustrated example also includes one or more mass storage discs or devices 1728 to store firmware, software, and/or data. Examples of such mass storage discs or devices 1728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1732, which may be implemented by the machine readable instructions of FIGS. 12, 13, 14, 15, and/or 16, may be stored in the mass storage device 1728, in the volatile memory 1714, in the non-volatile memory 1716, and/or on at least one non-transitory computer readable storage medium such as a CD or DVD which may be removable.

FIG. 18 is a block diagram of an example implementation of the programmable circuitry 1712 of FIG. 17. In this example, the programmable circuitry 1712 of FIG. 17 is implemented by a microprocessor 1800. For example, the microprocessor 1800 may be a general-purpose microprocessor (e.g., general-purpose microprocessor circuitry). The microprocessor 1800 executes some or all of the machine-readable instructions of the flowcharts of FIGS. 12, 13, 14, 15, and/or 16 to effectively instantiate the circuitry of FIG. 2 as logic circuits to perform operations corresponding to those machine readable instructions. In some such examples, the circuitry of FIG. 6 is instantiated by the hardware circuits of the microprocessor 1800 in combination with the machine-readable instructions. For example, the microprocessor 1800 may be implemented by multi-core hardware circuitry such as a CPU, a DSP, a GPU, an XPU, etc. Although it may include any number of example cores 1802 (e.g., 1 core), the microprocessor 1800 of this example is a multi-core semiconductor device including N cores. The cores 1802 of the microprocessor 1800 may operate independently or may cooperate to execute machine readable instructions. For example, machine code corresponding to a firmware program, an embedded software program, or a software program may be executed by one of the cores 1802 or may be executed by multiple ones of the cores 1802 at the same or different times. In some examples, the machine code corresponding to the firmware program, the embedded software program, or the software program is split into threads and executed in parallel by two or more of the cores 1802. The software program may correspond to a portion or all of the machine readable instructions and/or operations represented by the flowcharts of FIGS. 12, 13, 14, 15, and/or 16.

The cores 1802 may communicate by a first example bus 1804. In some examples, the first bus 1804 may be implemented by a communication bus to effectuate communication associated with one(s) of the cores 1802. For example, the first bus 1804 may be implemented by at least one of an Inter-Integrated Circuit (I2C) bus, a Serial Peripheral Interface (SPI) bus, a PCI bus, or a PCIe bus. Additionally or alternatively, the first bus 1804 may be implemented by any other type of computing or electrical bus. The cores 1802 may obtain data, instructions, and/or signals from one or more external devices by example interface circuitry 1806. The cores 1802 may output data, instructions, and/or signals to the one or more external devices by the interface circuitry 1806. Although the cores 1802 of this example include example local memory 1820 (e.g., Level 1 (L1) cache that may be split into an L1 data cache and an L1 instruction cache), the microprocessor 1800 also includes example shared memory 1810 that may be shared by the cores (e.g., Level 2 (L2 cache)) for high-speed access to data and/or instructions. Data and/or instructions may be transferred (e.g., shared) by writing to and/or reading from the shared memory 1810. The local memory 1820 of each of the cores 1802 and the shared memory 1810 may be part of a hierarchy of storage devices including multiple levels of cache memory and the main memory (e.g., the main memory 1714, 1716 of FIG. 17). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1802 may be referred to as a CPU, DSP, GPU, etc., or any other type of hardware circuitry. Each core 1802 includes control unit circuitry 1814, arithmetic and logic (AL) circuitry (sometimes referred to as an ALU) 1816, a plurality of registers 1818, the local memory 1820, and a second example bus 1822. Other structures may be present. For example, each core 1802 may include vector unit circuitry, single instruction multiple data (SIMD) unit circuitry, load/store unit (LSU) circuitry, branch/jump unit circuitry, floating-point unit (FPU) circuitry, etc. The control unit circuitry 1814 includes semiconductor-based circuits structured to control (e.g., coordinate) data movement within the corresponding core 1802. The AL circuitry 1816 includes semiconductor-based circuits structured to perform one or more mathematic and/or logic operations on the data within the corresponding core 1802. The AL circuitry 1816 of some examples performs integer based operations. In other examples, the AL circuitry 1816 also performs floating-point operations. In yet other examples, the AL circuitry 1816 may include first AL circuitry that performs integer-based operations and second AL circuitry that performs floating-point operations. In some examples, the AL circuitry 1816 may be referred to as an Arithmetic Logic Unit (ALU).

The registers 1818 are semiconductor-based structures to store data and/or instructions such as results of one or more of the operations performed by the AL circuitry 1816 of the corresponding core 1802. For example, the registers 1818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1818 may be arranged in a bank as shown in FIG. 18. Alternatively, the registers 1818 may be organized in any other arrangement, format, or structure, such as by being distributed throughout the core 1802 to shorten access time. The second bus 1822 may be implemented by at least one of an I2C bus, a SPI bus, a PCI bus, or a PCIe bus.

Each core 1802 and/or, more generally, the microprocessor 1800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1800 is a semiconductor device fabricated to include many transistors interconnected to implement the structures described above in one or more integrated circuits (ICs) contained in one or more packages.

The microprocessor 1800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1800, in the same chip package as the microprocessor 1800 and/or in one or more separate packages from the microprocessor 1800.

FIG. 19 is a block diagram of another example implementation of the programmable circuitry 1712 of FIG. 17. In this example, the programmable circuitry 1712 is implemented by FPGA circuitry 1900. For example, the FPGA circuitry 1900 may be implemented by an FPGA. The FPGA circuitry 1900 can be used, for example, to perform operations that could otherwise be performed by the example microprocessor 1800 of FIG. 18 executing corresponding machine readable instructions. However, once configured, the FPGA circuitry 1900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1800 of FIG. 18 described above (which is a general purpose device that may be programmed to execute some or all of the machine readable instructions represented by the flowchart(s) of FIGS. 12-16 but whose interconnections and logic circuitry are fixed once fabricated), the FPGA circuitry 1900 of the example of FIG. 19 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 12, 13, 14, 15, and/or 16. In particular, the FPGA circuitry 1900 may be thought of as an array of logic gates, interconnections, and switches. The switches can be programmed to change how the logic gates are interconnected by the interconnections, effectively forming one or more dedicated logic circuits (unless and until the FPGA circuitry 1900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 12, 13, 14, 15, and/or 16. As such, the FPGA circuitry 1900 may be configured and/or structured to effectively instantiate some or all of the operations/functions corresponding to the machine readable instructions of the flowchart(s) of FIGS. 12, 13, 14, 15, and/or 16 as dedicated logic circuits to perform the operations/functions corresponding to those software instructions in a dedicated manner analogous to an ASIC. Therefore, the FPGA circuitry 1900 may perform the operations/functions corresponding to the some or all of the machine readable instructions of FIGS. 12, 13, 14, 15, and/or 16 faster than the general-purpose microprocessor can execute the same.

In the example of FIG. 19, the FPGA circuitry 1900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1900 of FIG. 19 may access and/or load the binary file to cause the FPGA circuitry 1900 of FIG. 19 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1900 of FIG. 19 to cause configuration and/or structuring of the FPGA circuitry 1900 of FIG. 19, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1900 of FIG. 19 may access and/or load the binary file to cause the FPGA circuitry 1900 of FIG. 19 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1900 of FIG. 19 to cause configuration and/or structuring of the FPGA circuitry 1900 of FIG. 19, or portion(s) thereof.

The FPGA circuitry 1900 of FIG. 19, includes example input/output (I/O) circuitry 1902 to obtain and/or output data to/from example configuration circuitry 1904 and/or external hardware 1906. For example, the configuration circuitry 1904 may be implemented by interface circuitry that may obtain a binary file, which may be implemented by a bit stream, data, and/or machine-readable instructions, to configure the FPGA circuitry 1900, or portion(s) thereof. In some such examples, the configuration circuitry 1904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1906 may be implemented by external hardware circuitry. For example, the external hardware 1906 may be implemented by the microprocessor 1800 of FIG. 18.

The FPGA circuitry 1900 also includes an array of example logic gate circuitry 1908, a plurality of example configurable interconnections 1910, and example storage circuitry 1912. The logic gate circuitry 1908 and the configurable interconnections 1910 are configurable to instantiate one or more operations/functions that may correspond to at least some of the machine readable instructions of FIGS. 12, 13, 14, 15, and/or 16 and/or other desired operations. The logic gate circuitry 1908 shown in FIG. 19 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1908 to enable configuration of the electrical structures and/or the logic gates to form circuits to perform desired operations/functions. The logic gate circuitry 1908 may include other electrical structures such as look-up tables (LUTs), registers (e.g., flip-flops or latches), multiplexers, etc.

The configurable interconnections 1910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1908 to program desired logic circuits.

The storage circuitry 1912 of the illustrated example is structured to store result(s) of the one or more of the operations performed by corresponding logic gates. The storage circuitry 1912 may be implemented by registers or the like. In the illustrated example, the storage circuitry 1912 is distributed amongst the logic gate circuitry 1908 to facilitate access and increase execution speed.

The example FPGA circuitry 1900 of FIG. 19 also includes example dedicated operations circuitry 1914. In this example, the dedicated operations circuitry 1914 includes special purpose circuitry 1916 that may be invoked to implement commonly used functions to avoid the need to program those functions in the field. Examples of such special purpose circuitry 1916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1900 may also include example general purpose programmable circuitry 1918 such as an example CPU 1920 and/or an example DSP 1922. Other general purpose programmable circuitry 1918 may additionally or alternatively be present such as a GPU, an XPU, etc., that can be programmed to perform other operations.

Although FIGS. 18 and 19 illustrate two example implementations of the programmable circuitry 1712 of FIG. 17, many other approaches are contemplated. For example, FPGA circuitry may include an on-board CPU, such as one or more of the example CPU 1920 of FIG. 18. Therefore, the programmable circuitry 1712 of FIG. 17 may additionally be implemented by combining at least the example microprocessor 1800 of FIG. 18 and the example FPGA circuitry 1900 of FIG. 19. In some such hybrid examples, one or more cores 1802 of FIG. 18 may execute a first portion of the machine readable instructions represented by the flowchart(s) of FIGS. 12, 13, 14, 15, and/or 16 to perform first operation(s)/function(s), the FPGA circuitry 1900 of FIG. 19 may be configured and/or structured to perform second operation(s)/function(s) corresponding to a second portion of the machine readable instructions represented by the flowcharts of FIGS. 12-16, and/or an ASIC may be configured and/or structured to perform third operation(s)/function(s) corresponding to a third portion of the machine readable instructions represented by the flowcharts of FIGS. 12, 13, 14, 15, and/or 16.

It should be understood that some or all of the circuitry of FIG. 6 may, thus, be instantiated at the same or different times. For example, same and/or different portion(s) of the microprocessor 1800 of FIG. 18 may be programmed to execute portion(s) of machine-readable instructions at the same and/or different times. In some examples, same and/or different portion(s) of the FPGA circuitry 1900 of FIG. 19 may be configured and/or structured to perform operations/functions corresponding to portion(s) of machine-readable instructions at the same and/or different times.

In some examples, some or all of the circuitry of FIG. 6 may be instantiated, for example, in one or more threads executing concurrently and/or in series. For example, the microprocessor 1800 of FIG. 18 may execute machine readable instructions in one or more threads executing concurrently and/or in series. In some examples, the FPGA circuitry 1900 of FIG. 19 may be configured and/or structured to carry out operations/functions concurrently and/or in series. Moreover, in some examples, some or all of the circuitry of FIG. 6 may be implemented within one or more virtual machines and/or containers executing on the microprocessor 1800 of FIG. 18.

In some examples, the programmable circuitry 1712 of FIG. 17 may be in one or more packages. For example, the microprocessor 1800 of FIG. 18 and/or the FPGA circuitry 1900 of FIG. 19 may be in one or more packages. In some examples, an XPU may be implemented by the programmable circuitry 1712 of FIG. 17, which may be in one or more packages. For example, the XPU may include a CPU (e.g., the microprocessor 1800 of FIG. 18, the CPU 1920 of FIG. 19, etc.) in one package, a DSP (e.g., the DSP 1922 of FIG. 19) in another package, a GPU in yet another package, and an FPGA (e.g., the FPGA circuitry 1900 of FIG. 19) in still yet another package.

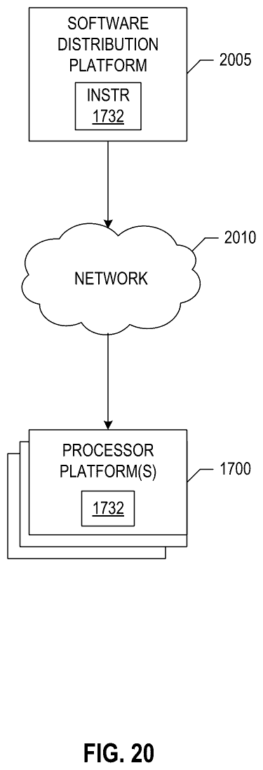

A block diagram illustrating an example software distribution platform 2005 to distribute software such as the example machine readable instructions 1732 of FIG. 17 to other hardware devices (e.g., hardware devices owned and/or operated by third parties from the owner and/or operator of the software distribution platform) is illustrated in FIG. 20. The example software distribution platform 2005 may be implemented by any computer server, data facility, cloud service, etc., capable of storing and transmitting software to other computing devices. The third parties may be customers of the entity owning and/or operating the software distribution platform 2005. For example, the entity that owns and/or operates the software distribution platform 2005 may be a developer, a seller, and/or a licensor of software such as the example machine readable instructions 1732 of FIG. 17. The third parties may be consumers, users, retailers, OEMs, etc., who purchase and/or license the software for use and/or re-sale and/or sub-licensing. In the illustrated example, the software distribution platform 2005 includes one or more servers and one or more storage devices. The storage devices store the machine readable instructions 1732, which may correspond to the example machine readable instructions of FIGS. 12, 13, 14, 15, and/or 16, as described above. The one or more servers of the example software distribution platform 2005 are in communication with an example network 2010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1732 from the software distribution platform 2005. For example, the software, which may correspond to the example machine readable instructions of FIG. 12-16, may be downloaded to the example programmable circuitry platform 1700, which is to execute the machine readable instructions 1732 to implement the main server 128. In some examples, one or more servers of the software distribution platform 2005 periodically offer, transmit, and/or force updates to the software (e.g., the example machine readable instructions 1732 of FIG. 17) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that monitor loading docks and facility operations by displaying graphics denoting the status of the facility in connection with (e.g., over) a map or layout of the facility. The graphics display a variety of information that allows a user to monitor the status of a dock relative to the other docks in the facility (and/or other equipment), while also granting a spatial awareness of the different docks along with indications of their operational states across different parts of the facility. This provides an advantage over traditional facility monitoring where the docks can be monitored individually or as part of a larger list, requiring a user to visualize and mentally retain a large amount of disparate status data.

Example methods, apparatus, systems, and articles of manufacture to monitor loading docks and facility operations by displaying graphics denoting the status of the facility within the context of a map or layout of the facility are disclosed herein. Further examples and combinations thereof include the following:

Example 1 includes an apparatus to monitor operations at a material handling facility, the apparatus comprising at least one memory, machine readable instructions, and at least one programmable circuit to be programmed by the machine readable instructions to present, via graphical user interface, a layout of the material handling facility, the layout including multiple locations where material handling equipment is to be represented, the locations corresponding to at least one of docks or doorways of the material handling facility, associate data from first equipment at a first one of the at least one of the docks or the doorways corresponding to a first location of the multiple locations included in the layout, and generate a graphic to be presented, via the graphical user interface, at the first location, the graphic based on the data from the first equipment.

Example 2 includes the apparatus of example 1, wherein the graphic is to indicate a state of the first one of the at least one of the docks or the doorways, and the graphic is to change responsive to a change in the state of the first one of the at least one of the docks or the doorways.

Example 3 includes the apparatus of example 2, wherein the graphic is to change in substantially real-time with the change in the state of the first one of the at least one of the docks or the doorways.

Example 4 includes the apparatus of any one of examples 1-3, wherein one or more of the at least one programmable circuit is to discover the first equipment at the first one of the at least one of the docks or the doorways based on a signal from the first equipment, and designate the first equipment as associated with the first one of the at least one of the docks or the doorways based on a user input.

Example 5 includes the apparatus of example 4, wherein the signal is a first signal and the user input is a first user input, one or more of the at least one programmable circuit to cause the discovered first equipment to be visually distinguished on a graphical user interface from among other discovered equipment at other ones of the at least one of the docks or the doorways based on a second signal from the first equipment, the second signal generated in response to a second user input received by the first equipment, the discovered first equipment to be visually distinguished to facilitate a user to provide the first user input.

Example 6 includes the apparatus of any one of examples 1-5, wherein one or more of the at least one programmable circuit is to present, via the graphical user interface, a sizing graphic, the sizing graphic to define a size of the graphic relative to a size of the layout.

Example 7 includes the apparatus of example 6, wherein the sizing graphic measures a width of the first location based on a user adjusting ends of the sizing graphic relative to the width of the first location within the layout.

Example 8 includes the apparatus of any one of examples 1-7, wherein the associating of the data with the first location is based on a user input identifying the first location included in the layout as corresponding to the first one of the at least one of the docks or the doorways of the material handling facility.

Example 9 includes the apparatus of example 8, wherein the user input includes moving a marker to the first location included in the layout, the marker associated with the first equipment.

Example 10 includes the apparatus of example 9, wherein the marker is one of a plurality of markers, different ones of the plurality of markers corresponding to different ones of the at least one of the docks or the doorways of the material handling facility, ones of the plurality of markers not associated with corresponding ones of the multiple locations included in the layout to be positioned in an asset list, the asset list proximate and independent from the layout.

Example 11 includes the apparatus of any one of examples 9 or 10, wherein the user input includes rotating the marker to align with an orientation of the first location included in the layout.

Example 12 includes the apparatus of any one of examples 1-11, wherein one or more of the at least one programmable circuit is to associate a second one of the at least one of the docks or the doorways with a corresponding second location of the multiple locations included in the layout, and present a second graphic at the second location.

Example 13 includes the apparatus of any one of examples 1-12, wherein one or more of the at least one programmable circuit is to switch between presentation of a first portion of the layout and presentation of a second portion of the layout, the second portion of the layout corresponding to less of the layout than the first portion of the layout, the second portion of the layout enlarged relative to the first portion of the layout.

Example 14 includes the apparatus of example 13, wherein the second portion of the layout contains the first location.

Example 15 includes a non-transitory machine readable storage medium comprising instructions to cause at least one programmable circuit to at least present, via graphical user interface, a layout of a material handling facility, the layout including multiple locations where material handling equipment is to be represented, the locations corresponding to at least one of docks or doorways of the material handling facility, associate data from first equipment at a first one of the at least one of the docks or the doorways corresponding to a first location of the multiple locations included in the layout, and generate a graphic to be presented, via the graphical user interface, at the first location, the graphic based on the data from the first equipment.

Example 16 includes the non-transitory machine readable storage medium of example 15, wherein the graphic is to indicate a state of the first one of the at least one of the docks or the doorways, and the graphic is to change responsive to a change in the state of the first one of the at least one of the docks or the doorways.

Example 17 includes the non-transitory machine readable storage medium of example 16, wherein the graphic is to change in substantially real-time with the change in the state of the first one of the at least one of the docks or the doorways.

Example 18 includes the non-transitory machine readable storage medium of any one of examples 15-17, wherein the instructions cause one or more of the at least one programmable circuit to discover the first equipment at the first one of the at least one of the docks or the doorways based on a signal from the first equipment, and designate the first equipment as associated with the first one of the at least one of the docks or the doorways based on a user input.

Example 19 includes the non-transitory machine readable storage medium of example 18, wherein the signal is a first signal and the user input is a first user input, the instructions to further cause one or more of the at least one programmable circuit to cause the discovered first equipment to be visually distinguished on a graphical user interface from among other discovered equipment at other ones of the at least one of the docks or the doorways based on a second signal from the first equipment, the second signal generated in response to a second user input received by the first equipment, the discovered first equipment to be visually distinguished to facilitate a user to provide the first user input.

Example 20 includes the non-transitory machine readable storage medium of any one of examples 15-19, wherein the instructions cause one or more of the at least one programmable circuit to present, via the graphical user interface, a sizing graphic, the sizing graphic to define a size of the graphic relative to a size of the layout.

Example 21 includes the non-transitory machine readable storage medium of example 20, wherein the sizing graphic measures a width of the first location based on a user adjusting ends of the sizing graphic relative to the width of the first location within the layout.

Example 22 includes the non-transitory machine readable storage medium of any one of examples 15-21, wherein the associating of the data with the first location is based on a user input identifying the first location included in the layout as corresponding to the first one of the at least one of the docks or the doorways of the material handling facility.

Example 23 includes the non-transitory machine readable storage medium of example 22, wherein the user input includes moving a marker to the first location included in the layout, the marker associated with the first equipment.

Example 24 includes the non-transitory machine readable storage medium of example 23, wherein the marker is one of a plurality of markers, different ones of the plurality of markers corresponding to different ones of the at least one of the docks or the doorways of the material handling facility, ones of the plurality of markers not associated with corresponding ones of the multiple locations included in the layout to be positioned in an asset list, the asset list proximate and independent from the layout.

Example 25 includes the non-transitory machine readable storage medium of any one of examples 23 or 24, wherein the user input includes rotating the marker to align with an orientation of the first location included in the layout.

Example 26 includes the non-transitory machine readable storage medium of any one of examples 15-25, wherein the instructions cause one or more of the at least one programmable circuit to associate a second one of the at least one of the docks or the doorways with a corresponding second location of the multiple locations included in the layout, and present a second graphic at the second location.

Example 27 includes the non-transitory machine readable storage medium of any one of examples 15-26, wherein the instructions further cause one or more of the at least one programmable circuit to switch between presentation of a first portion of the layout and presentation of a second portion of the layout, the second portion of the layout corresponding to less of the layout than the first portion of the layout, the second portion of the layout enlarged relative to the first portion of the layout.

Example 28 includes the non-transitory machine readable storage medium of example 27, wherein the second portion of the layout contains the first location.

Example 29 includes a method comprising presenting, via graphical user interface, a map of a material handling facility, the map depicting multiple locations where material handling equipment is to be represented, the locations corresponding to at least one of docks or doorways of the material handling facility, associating, by operating at least one programmable circuit based on instructions, data from first equipment at a first one of the at least one of the docks or the doorways corresponding to a first location of the multiple locations depicted in the map, and generating a graphic to be presented, via the graphical user interface, at the first location, the graphic based on the data from the first equipment.

Example 30 includes the method of example 29, wherein the graphic is to indicate a state of the first one of the at least one of the docks or the doorways, and the graphic is to change responsive to a change in the state of the first one of the at least one of the docks or the doorways.

Example 31 includes the method of example 30, wherein the graphic is to change in substantially real-time with the change in the state of the first one of the at least one of the docks or the doorways.

Example 32 includes the method of any one of examples 29-31, further including detecting the first equipment at the first one of the at least one of the docks or the doorways based on a signal from the first equipment, and designating the first equipment as associated with the first one of the at least one of the docks or the doorways based on a user input.

Example 33 includes the method of example 32, wherein the signal is a first signal and the user input is a first user input, the method further including visually distinguishing the detected first equipment on a graphical user interface from among other detected assets at other ones of the at least one of the docks or the doorways based on a second signal from the first equipment, the second signal generated in response to a second user input received by the first equipment, the detected first equipment to be visually distinguished to facilitate a user to provide the first user input.

Example 34 includes the method of any one of examples 29-33, further including presenting, via the graphical user interface, a sizing graphic, the sizing graphic to define a size of the graphic relative to a size of the map.

Example 35 includes the method of example 34, wherein the sizing graphic measures a width of the first location based on a user adjusting ends of the sizing graphic relative to the width of the first location within the map.

Example 36 includes the method of any one of examples 29-35, wherein the associating of the data with the first location is based on a user input identifying the first location depicted in the map as corresponding to the first one of the at least one of the docks or the doorways of the material handling facility.

Example 37 includes the method of example 36, wherein the user input includes moving a dock marker to the first location depicted in the map, the marker associated with the first equipment.

Example 38 includes the method of example 37, wherein the marker is one of a plurality of markers, different ones of the plurality of markers corresponding to different ones of the at least one of the docks or the doorways of the material handling facility, ones of the plurality of markers not associated with corresponding ones of the multiple locations depicted in the map to be positioned in an asset list, the asset list proximate and independent from the map.

Example 39 includes the method of any one of examples 37 or 38, wherein the user input includes rotating the marker to align with an orientation of the first location depicted in the map.

Example 40 includes the method of any one of examples 29-39, further including associating a second one of the at least one of the docks or the doorways with a corresponding second location of the multiple locations depicted in the map, and presenting a second graphic at the second location.

Example 41 includes the method of any one of examples 29-40, further including switching between presentation of a first portion of the map and presentation of a second portion of the map, the second portion of the map corresponding to less of the map than the first portion of the map, the second portion of the map enlarged relative to the first portion of the map.

Example 42 includes the method of example 41, wherein the second portion of the map contains the first location.

Example 43 includes an apparatus comprising at least one memory, machine readable instructions, and at least one programmable circuit to be programmed by the machine readable instructions to identify a type of controller associated with equipment in a material handling facility based on device identification information received from the controller, the type corresponding to either a dock controller or a door controller, and discover a piece of equipment associated with the controller based on IO data received from the controller, the IO data including a signal provided to the controller from the piece of equipment, the signal indicative of the equipment undergoing a state change.

Example 44 includes the apparatus of example 43, wherein one or more of the at least one programmable circuit is to determine a type of the piece of equipment based on an address received from the controller, the address provided with the signal.

Example 45 includes the apparatus of any one of examples 43 or 44, wherein the piece of equipment is a first piece of equipment, and one or more of the at least one programmable circuit is to discover multiple pieces of equipment associated with the controller based on the IO data received from the controller, the multiple pieces of equipment including the first piece of equipment.

Example 46 includes the apparatus of any one of examples 43-45, wherein the controller is a first controller, and one or more of the at least one programmable circuit is to generate a list of assets including multiple controllers, the multiple controllers including the first controller.

Example 47 includes the apparatus of example 46, wherein one or more of the at least one programmable circuit is to associate different pieces of discovered equipment with different ones of the multiple controllers.

Example 48 includes the apparatus of any one of examples 46 or 47, wherein one or more of the at least one programmable circuit is to cause the list of assets to be displayed in a graphical user interface.

Example 49 includes the apparatus of any one of examples 46 or 48, wherein the list of assets includes an indicator associated with each of the multiple controllers, and one or more of the at least one programmable circuit is to cause a first one of the indicators to change appearance in response to receiving an equipment identifying signal from a corresponding first one of the controllers.

Example 50 includes a non-transitory machine readable storage medium comprising instructions to cause at least one programmable circuit to at least identify a type of controller associated with equipment in a material handling facility based on device identification information received from the controller, the type corresponding to either a dock controller or a door controller, and discover a piece of equipment associated with the controller based on IO data received from the controller, the IO data including a signal provided to the controller from the piece of equipment, the signal indicative of the equipment undergoing a state change.

Example 51 includes the non-transitory machine readable storage medium of example 50, wherein the instructions cause one or more of the at least one programmable circuit to determine a type of the piece of equipment based on an address received from the controller, the address provided with the signal.

Example 52 includes the non-transitory machine readable storage medium of any one of examples 50 or 51, wherein the piece of equipment is a first piece of equipment, and the instructions cause one or more of the at least one programmable circuit to discover multiple pieces of equipment associated with the controller based on the IO data received from the controller, the multiple pieces of equipment including the first piece of equipment.

Example 53 includes the non-transitory machine readable storage medium of any one of examples 50-52, wherein the controller is a first controller, and the instructions cause one or more of the at least one programmable circuit to generate a list of assets including multiple controllers, the multiple controllers including the first controller.

Example 54 includes the non-transitory machine readable storage medium of example 53, wherein the instructions cause one or more of the at least one programmable circuit to associate different pieces of discovered equipment with different ones of the multiple controllers.

Example 55 includes the non-transitory machine readable storage medium of any one of examples 53 or 54, wherein the instructions cause one or more of the at least one programmable circuit to cause the list of assets to be displayed in a graphical user interface.

Example 56 includes the non-transitory machine readable storage medium of any one of examples 53-55, wherein the list of assets includes an indicator associated with each of the multiple controllers, and the instructions cause one or more of the at least one programmable circuit to cause a first one of the indicators to change appearance in response to receiving an equipment identifying signal from a corresponding first one of the controllers.

Example 57 includes a method comprising identifying a type of controller associated with equipment in a material handling facility based on device identification information received from the controller, the type corresponding to either a dock controller or a door controller, and identifying, by operating at least one programmable circuit based on instructions, a piece of equipment associated with the controller based on IO data received from the controller, the IO data including a signal provided to the controller from the piece of equipment, the signal indicative of the equipment undergoing a state change.

Example 58 includes the method of example 57, further including determining a type of the piece of equipment based on an address received from the controller, the address provided with the signal.

Example 59 includes the method of any one of examples 57 or 58, wherein the piece of equipment is a first piece of equipment, the method further including identifying multiple pieces of equipment associated with the controller based on the IO data received from the controller, the multiple pieces of equipment including the first piece of equipment.

Example 60 includes the method of any one of examples 57-59, wherein the controller is a first controller, the method further including generating a list of assets including multiple controllers, the multiple controllers including the first controller.

Example 61 includes the method of example 60, further including associating different pieces of discovered equipment with different ones of the multiple controllers.

Example 62 includes the method of any one of examples 60 or 61, further including presenting the list of assets in a graphical user interface.

Example 63 includes the method of any one of examples 60-62, wherein the list of assets includes an indicator associated with each of the multiple controllers, the method further including causing a first one of the indicators to change appearance in response to receiving an equipment identifying signal from a corresponding first one of the controllers.

Example 64 includes an apparatus comprising at least one memory, machine readable instructions, and at least one programmable circuit to be programmed by the machine readable instructions to cause a layout of a material handling facility to be presented via graphical user interface, and determine a scale of the layout based on a size of an adjustable sizing graphic after user input has adjusted the size of the sizing graphic relative to the layout.

Example 65 includes the apparatus of example 64, wherein one or more of the at least one programmable circuit is to enable the sizing graphic to be at least one of rotated or moved relative to the layout to enable a user to adjust the size of the sizing graphic to match a dimension of a feature shown in the layout.

Example 66 includes the apparatus of example 65, wherein the feature corresponds to a doorway at a loading dock of the material handling facility.

Example 67 includes the apparatus of any one of examples 65 or 66, wherein the feature has a standard width that one or more of the at least one programmable circuit is to retrieve from the at least one memory to determine the scale of the layout.

Example 68 includes the apparatus of any one of examples 65-67, wherein the dimension is specified by a user, and one or more of the at least one programmable circuit is to determine the scale of the layout based on the user-specified dimension.

Example 69 includes the apparatus of any one of examples 64-68, wherein one or more of the at least one programmable circuit is to generate markers for display on the layout, the markers corresponding to equipment detected at corresponding ones of at least one of docks or doorways of the material handling facility, the markers to be moveable by a user into positions on the layout corresponding to locations of the corresponding ones of the at least one of the docks or the doorways of the material handling facility, the markers dimensioned based on the determined scale of the layout.

Example 70 includes the apparatus of example 69, wherein one or more of the at least one programmable circuit is to generate graphics at the positions of corresponding ones of the markers, the graphics including one or more symbols indicative of the equipment detected at the corresponding ones of the at least one of the docks or the doorways, the graphics dimensioned based on the determined scale of the layout.

Example 71 includes a non-transitory machine readable storage medium comprising instructions to cause at least one programmable circuit to at least cause a layout of a material handling facility to be presented via graphical user interface, and determine a scale of the layout based on a size of an adjustable sizing graphic after user input has adjusted the size of the sizing graphic relative to the layout.

Example 72 includes the non-transitory machine readable storage medium of example 71, wherein the instructions are to cause one or more of the at least one programmable circuit to enable the sizing graphic to be at least one of rotated or moved relative to the layout to enable a user to adjust the size of the sizing graphic to match a dimension of a feature shown in the layout.

Example 73 includes the non-transitory machine readable storage medium of example 72, wherein the feature corresponds to a doorway at a loading dock of the material handling facility.

Example 74 includes the non-transitory machine readable storage medium of any one of examples 72 or 73, wherein the feature has a standard width, the instructions to cause one or more of the at least one programmable circuit to retrieve the standard width from memory to determine the scale of the layout.

Example 75 includes the non-transitory machine readable storage medium of any one of examples 72-74, wherein the dimension is specified by a user, and the instructions are to cause one or more of the at least one programmable circuit to determine the scale of the layout based on the user-specified dimension.

Example 76 includes the non-transitory machine readable storage medium of any one of examples 71-75, wherein the instructions are to cause one or more of the at least one programmable circuit to generate markers for display on the layout, the markers corresponding to equipment detected at corresponding ones of at least one of docks or doorways of the material handling facility, the markers to be moveable by a user into positions on the layout corresponding to locations of the corresponding ones of the at least one of the docks or the doorways of the material handling facility, the markers dimensioned based on the determined scale of the layout.

Example 77 includes the non-transitory machine readable storage medium of example 76, wherein the instructions are to cause one or more of the at least one programmable circuit to generate graphics at the positions of corresponding ones of the markers, the graphics including one or more symbols indicative of the equipment detected at the corresponding ones of the at least one of the docks or the doorways, the graphics dimensioned based on the determined scale of the layout.

Example 78 includes a method comprising presenting, via a graphical user interface, a layout of a material handling facility, and determining, by operating at least one programmable circuit based on instructions, a scale of the layout based on a size of an adjustable sizing graphic after user input has adjusted the size of the sizing graphic relative to the layout.

Example 79 includes the method of example 78, further including enabling the sizing graphic to be at least one of rotated or moved relative to the layout to enable a user to adjust the size of the sizing graphic to match a dimension of a feature shown in the layout.

Example 80 includes the method of example 79, wherein the feature corresponds to a doorway at a loading dock of the material handling facility.

Example 81 includes the method of any one of examples 79 or 80, further including retrieving a standard width for the feature from memory, the determining of the scale of the layout based on the standard width.

Example 82 includes the method of any one of examples 79-81, wherein the dimension is specified by a user, and the determining of the scale of the layout is based on the user-specified dimension.

Example 83 includes the method of any one of examples 78-82, further including generating markers for display on the layout, the markers corresponding to equipment detected at corresponding ones of at least one of docks or doorways of the material handling facility, the markers to be moveable by a user into positions on the layout corresponding to locations of the corresponding ones of the at least one of the docks or the doorways of the material handling facility, the markers dimensioned based on the determined scale of the layout.

Example 84 includes the method of example 83, further including generating graphics at the positions of corresponding ones of the markers, the graphics including one or more symbols indicative of the equipment detected at the corresponding ones of the at least one of the docks or the doorways, the graphics dimensioned based on the determined scale of the layout.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus to monitor operations at a material handling facility, the apparatus comprising:
at least one memory;
machine readable instructions; and
at least one programmable circuit to be programmed by the machine readable instructions to:
present, via graphical user interface, a layout of the material handling facility, the layout including multiple locations where material handling equipment is to be represented, the locations corresponding to at least one of docks or doorways of the material handling facility;
associate data from first equipment at a first one of the at least one of the docks or the doorways corresponding to a first location of the multiple locations included in the layout; and
generate a graphic to be presented, via the graphical user interface, at the first location, the graphic based on the data from the first equipment.

2. The apparatus of claim 1, wherein the graphic is to indicate a state of the first one of the at least one of the docks or the doorways, and the graphic is to change responsive to a change in the state of the first one of the at least one of the docks or the doorways.

3. The apparatus of claim 2, wherein the graphic is to change in substantially real-time with the change in the state of the first one of the at least one of the docks or the doorways.

4. The apparatus of claim 1, wherein one or more of the at least one programmable circuit is to:
discover the first equipment at the first one of the at least one of the docks or the doorways based on a signal from the first equipment; and
designate the first equipment as associated with the first one of the at least one of the docks or the doorways based on a user input.

5. The apparatus of claim 4, wherein the signal is a first signal and the user input is a first user input, one or more of the at least one programmable circuit to cause the discovered first equipment to be visually distinguished on a graphical user interface from among other discovered equipment at other ones of the at least one of the docks or the doorways based on a second signal from the first equipment, the second signal generated in response to a second user input received by the first equipment, the discovered first equipment to be visually distinguished to facilitate a user to provide the first user input.

6. The apparatus of claim 1, wherein one or more of the at least one programmable circuit is to present, via the graphical user interface, a sizing graphic, the sizing graphic to define a size of the graphic relative to a size of the layout.

7. The apparatus of claim 6, wherein the sizing graphic measures a width of the first location based on a user adjusting ends of the sizing graphic relative to the width of the first location within the layout.

8. The apparatus of claim 1, wherein the associating of the data with the first location is based on a user input identifying the first location included in the layout as corresponding to the first one of the at least one of the docks or the doorways of the material handling facility.

9. The apparatus of claim 8, wherein the user input includes moving a marker to the first location included in the layout, the marker associated with the first equipment.

10. The apparatus of claim 9, wherein the marker is one of a plurality of markers, different ones of the plurality of markers corresponding to different ones of the at least one of the docks or the doorways of the material handling facility, ones of the plurality of markers not associated with corresponding ones of the multiple locations included in the layout to be positioned in an asset list, the asset list proximate and independent from the layout.

11. The apparatus of claim 9, wherein the user input includes rotating the marker to align with an orientation of the first location included in the layout.

12. (canceled)

13. (canceled)

14. (canceled)

15. A non-transitory machine readable storage medium comprising instructions to cause at least one programmable circuit to at least:
present, via graphical user interface, a layout of a material handling facility, the layout including multiple locations where material handling equipment is to be represented, the locations corresponding to at least one of docks or doorways of the material handling facility;
associate data from first equipment at a first one of the at least one of the docks or the doorways corresponding to a first location of the multiple locations included in the layout; and
generate a graphic to be presented, via the graphical user interface, at the first location, the graphic based on the data from the first equipment.

16. The non-transitory machine readable storage medium of claim 15, wherein the graphic is to indicate a state of the first one of the at least one of the docks or the doorways, and the graphic is to change responsive to a change in the state of the first one of the at least one of the docks or the doorways.

17. The non-transitory machine readable storage medium of claim 16, wherein the graphic is to change in substantially real-time with the change in the state of the first one of the at least one of the docks or the doorways.

18. The non-transitory machine readable storage medium of claim 15, wherein the instructions cause one or more of the at least one programmable circuit to:
discover the first equipment at the first one of the at least one of the docks or the doorways based on a signal from the first equipment; and
designate the first equipment as associated with the first one of the at least one of the docks or the doorways based on a user input.

19. The non-transitory machine readable storage medium of claim 18, wherein the signal is a first signal and the user input is a first user input, the instructions to further cause one or more of the at least one programmable circuit to cause the discovered first equipment to be visually distinguished on a graphical user interface from among other discovered equipment at other ones of the at least one of the docks or the doorways based on a second signal from the first equipment, the second signal generated in response to a second user input received by the first equipment, the discovered first equipment to be visually distinguished to facilitate a user to provide the first user input.

20. The non-transitory machine readable storage medium of claim 15, wherein the instructions cause one or more of the at least one programmable circuit to present, via the graphical user interface, a sizing graphic, the sizing graphic to define a size of the graphic relative to a size of the layout.

21. The non-transitory machine readable storage medium of claim 20, wherein the sizing graphic measures a width of the first location based on a user adjusting ends of the sizing graphic relative to the width of the first location within the layout.

22. The non-transitory machine readable storage medium of claim 15, wherein the associating of the data with the first location is based on a user input identifying the first location included in the layout as corresponding to the first one of the at least one of the docks or the doorways of the material handling facility.

23. The non-transitory machine readable storage medium of claim 22, wherein the user input includes moving a marker to the first location included in the layout, the marker associated with the first equipment.

24. The non-transitory machine readable storage medium of claim 23, wherein the marker is one of a plurality of markers, different ones of the plurality of markers corresponding to different ones of the at least one of the docks or the doorways of the material handling facility, ones of the plurality of markers not associated with corresponding ones of the multiple locations included in the layout to be positioned in an asset list, the asset list proximate and independent from the layout.

25. The non-transitory machine readable storage medium of claim 23, wherein the user input includes rotating the marker to align with an orientation of the first location included in the layout.

26.-84. (canceled)
